(19) United States
(12) Patent Application Publication
(10) Pub. No.: US 2026/0005331 A1
(43) Pub. Date: Jan. 1, 2026

(54) BATTERY CELLS WITH THERMALLY CONDUCTIVE POTTING

(71) Applicant: Kyma Batteries LLC, Dallas, TX (US)

(72) Inventor: Travis Cournoyer, Hawthorne, CA (US)

(21) Appl. No.: 18/756,617

(22) Filed: Jun. 27, 2024

(51) Int. Cl. H01M 10/653; H01M 10/613; H01M 10/643

(52) U.S. Cl. CPC H01M 10/653; H01M 10/613; H01M 10/643

(57) ABSTRACT

In accordance with some embodiments of the present disclosure, a battery cell includes a cooling structure, a plurality of energy units thermally coupled to the cooling structure via a first interface, and a thermally conductive potting material that thermally couples the plurality of energy units to each other and to the cooling structure via a second interface. In some embodiments, the thermally conductive potting material is electrically conductive. In some embodiments, the first interface is between a side of the cooling structure and respective ends of the cylindrical energy units, and the second interface is between the side of the cooling structure and respective cylindrical sides of the energy units. In some embodiments, the plurality of energy units are electrically coupled in parallel. In some embodiments, the battery cell also includes an adhesive that thermally couples the plurality of energy units to the cooling structure via the first interface.

### INTRODUCTION

The present disclosure is directed to battery cells. In some embodiments, a center post is provided for mechanical support of prismatic battery cells. In some embodiments, a cooling configuration is provided for thermal management of the battery cells. In some embodiments, a thermally conductive potting material is provided for mechanical and thermal support of the battery cells. In some embodiments, a battery cell housing with a removable side is provided for the battery cells. In some embodiments, a configuration is provided for electrical coupling to cylindrical energy units of the battery cells. In some embodiments, a configuration is provided for electrical coupling to pouch energy units of the battery cells. In some embodiments, a vent configuration is provided for outgas management of the battery cells.

### SUMMARY

A prismatic battery cell is a battery cell with a rectangular housing. A prismatic battery cell, as well as other types of battery cells, may include one or more discrete energy units that are configured to store and release electrical energy via one or more reversible chemical reactions.

Battery cells (including, but not limited to, prismatic battery cells) may provide uninterrupted power, may provide power when there is no other available power supply, may be the sole power supply for certain equipment, may store energy to be used later (e.g., for energy arbitrage, improved energy efficiency, backup power, reduction of emissions associated with energy consumption, use with intermittent renewable energy generation, or any combination thereof), may power electric vehicles, or may serve any other suitable energy application. In some embodiments, multiple battery cells (each of which may include multiple energy units) may be combined (e.g., in series, in parallel, or in a combination thereof) to provide a target amount of power.

Battery cells such as prismatic battery cells can provide electrical power from within packages that may be mechanically robust, electrically insulated, thermally stable, capable of venting gases, designed for maintenance through a lifetime of use in the field, or any combination thereof. Various tradeoffs and degrees of freedom in battery cell design may influence the resulting mechanical, electrical, thermal, venting, and maintenance properties.

Battery cells may be punctured, dented, crushed, or otherwise exposed to mechanical stress that can damage internal components of the battery cell. Battery cells may also swell with aging as electrolyte volatilizes from multiple cycles, which separates the electrode layers within and increases internal resistance. To protect the battery cell against these stresses, sidewalls of a housing containing one or more battery cells such as prismatic battery cells may be reinforced to provide protection against mechanical stress, or a casing around the housing may be configured to provide protection against mechanical stress. However, these approaches may not be sufficiently mechanically robust, or they may require an undesirable increase in the volume, materials, mass, or ease of integration of the battery cell. In accordance with some embodiments of the present disclosure, a center post is provided within a housing of the prismatic battery cell to protect the battery cell from mechanical stress.

In accordance with some embodiments of the present disclosure, a prismatic battery cell includes a housing defining an internal volume, wherein a smallest dimension component of the housing is between first and second sides of the housing, and a center post is coupled between the first and second sides of the housing.

In some embodiments, the smallest dimension component corresponds to an axis and the center post is parallel to the axis.

In some embodiments, the center post includes first and second end plates and a rod connecting the first and second end plates, where the first end plate is affixed to the first side and the second end plate is affixed to the second side.

In some embodiments, the center post includes a center vent structure configured to receive gas released from one or more energy units and release the gas outside of the housing.

In some embodiments, the center post spans respective regions of the first and second sides, and the respective regions do not extend to any edges of the first and second sides.

In some embodiments, the first and second sides of the housing each have a bowed out shape.

In some embodiments, the housing includes a removable side mechanically coupled to the center post, and the bowed out shape of the first and second sides provide a clearance for the center post when the removable side is removed from the housing.

In some embodiments, the prismatic battery cell also includes a plurality of energy units surrounding the center post.

In some embodiments, the plurality of energy units are electrically coupled in parallel.

In some embodiments, each of the plurality of energy units includes an output voltage that corresponds to an output voltage of the prismatic battery cell.

In some embodiments, the prismatic battery cell also includes a cooling structure thermally coupled to a plurality of energy units, wherein one end of the center post is coupled to the first side of the housing via the cooling structure.

In some embodiments, the center post has a yield strength of at least 100 MPa.

In accordance with some embodiments of the present disclosure, a battery cell includes a housing including six sides, wherein a smallest dimension component between opposite sides of the housing is between first and second sides of the housing, and a center post coupled between the first and second sides.

In some embodiments, the center post spans respective regions of the first and second sides, and the respective regions do not extend to any edges of the first and second sides.

In some embodiments, one of the six sides parallel to the smallest dimension component is a removable side coupled to the center post, and the removable side includes two electrical terminals. In some embodiments, the battery cell also includes a plurality of energy units electrically coupled in parallel, wherein each of the plurality of energy units includes an output voltage that corresponds to an output voltage of the two electrical terminals.

In some embodiments, the battery cell also includes a plurality of energy units surrounding the center post.

In accordance with some embodiments of the present disclosure, a center post for a battery cell includes first and second end plates, and a rod connecting the first and second end plates, wherein the first end plate is for coupling to a first side of the battery cell and the second end plate is for coupling to a second side of the battery cell.

In some embodiments, the first and second end plates each include a rectangular shape configured to span a center portion of a respective one of the first and second sides of the battery cell without contacting any edges of the respective one of the first and second sides of the battery cell.

In some embodiments, the center post has a yield strength of at least 100 MPa.

Battery cells such as prismatic battery cells may risk overheating, which may, for example, damage internal components of the battery cell. In accordance with embodiments of the present disclosure, a cooling system (e.g., extending beyond the housing of a battery cell) includes a coolant line that runs through the housing and couples to a cooling structure within the housing to cool internal components of the battery cell.

In accordance with some embodiments of the present disclosure, a battery cell includes a housing including at least one inlet port and at least one outlet port, at least one coolant line extending between the at least one inlet port and the at least one outlet port, at least one energy unit arranged within the housing, and a cooling structure coupled to the at least one coolant line, wherein the cooling structure is thermally coupled to the at least one energy unit.

In some embodiments, the at least one inlet port, at least one outlet port, and at least one coolant line include a first inlet port, a first outlet port, a first coolant line extending between the first inlet port and the first outlet port, a second inlet port, a second outlet port, and a second coolant line extending between the second inlet port and the second outlet port, wherein the first coolant line and second coolant line are coupled to the cooling structure.

In some embodiments, the first coolant line is configured to supply a coolant and the second coolant line is configured to return a coolant.

In some embodiments, the first coolant line is configured to receive a coolant from a cooling system at a first temperature and the second coolant line is configured to return the coolant to the cooling system at a second temperature, greater than the first temperature. In some embodiments, the cooling system is configured to heat the at least one energy unit, and the second temperature is less than the first temperature.

In some embodiments, the first coolant line is parallel to the second coolant line.

In some embodiments, respective ends of the coolant line include respective sockets, each configured to couple to one of the at least one inlet port and the at least one outlet port.

In some embodiments, at least one of the sockets is configured to mate with a cooling line of an additional battery cell.

In some embodiments, the housing is diagonally symmetric, such that upon rotating the battery cell by 180 degrees, the at least one socket remains configured to mate with the cooling line of the additional battery cell.

In some embodiments, the at least one coolant line includes a single coolant line and the cooling structure is configured to receive a coolant from the single coolant line and provide the coolant to the single coolant line.

In some embodiments, the coolant is a liquid coolant and a portion of each energy unit of the at least one energy unit is submerged in the coolant.

In accordance with some embodiments of the present disclosure, a battery cell includes a housing including at least one inlet port and at least one outlet port, a cooling structure, and at least one energy unit, where each of the at least one energy unit is thermally coupled to the cooling structure. The cooling structure comprises a structure first side, a structure second side, and at least one fluid path defined by a baffle structure in between the structure first side and the structure second side, where an inlet of the at least one fluid path is coupled to the inlet port and an outlet of the at least one fluid path is coupled to the outlet port.

In some embodiments, the battery cell also includes at least one coolant line extending between the least one inlet port and the at least one outlet port, where the at least one coolant line is fluidically coupled to the at least one fluid path.

In some embodiments, the at least one inlet port, at least one outlet port, and at least one coolant line include a first inlet port, a first outlet port, a first coolant line extending between the first inlet port and the first outlet port, a second inlet port, a second outlet port, and a second coolant line extending between the second inlet port and the second outlet port, where the first coolant line and second coolant line couple the fluid to the at least one fluid path. In some embodiments, the first coolant line is configured to supply a fluid to the at least one fluid path and the second coolant line is configured to receive the fluid from the at least one fluid path. In some embodiments, the first coolant line supplies the fluid at a first temperature, and the second coolant line receives the fluid at a second temperature, greater than the first temperature.

In some embodiments, respective ends of the coolant line include respective sockets, each configured to couple to one of the at least one inlet port and the at least one outlet port. In some embodiments, at least one of the sockets is configured to mate with a cooling line of an additional battery cell.

In some embodiments, the housing is diagonally symmetric, such that upon rotating the battery cell by 180 degrees, the at least one socket remains configured to mate with the cooling line of the additional battery cell.

In some embodiments, the cooling structure includes first and second coolant ports, the first coolant port is coupled to at least one inlet port, and the second coolant port is coupled to at least one outlet port.

In some embodiments, the cooling structure also includes a plurality of holes, and the structure first side is mechanically coupled to a housing side by fasteners extending through the plurality of holes.

Battery cells may include a potting material to stabilize one or more energy units within the prismatic battery cell. This potting material may be thermally and/or electrically insulating (e.g., to avoid having the potting material electrically or thermally couple multiple of the respective energy units). However, such insulating properties may prevent the potting material from contributing to thermal and/or electrical management of the prismatic battery cell. In accordance with some embodiments of the present disclosure, a thermally conductive potting material mechanically stabilizes one or more energy units of the battery cell and contributes to thermal management of the one or more energy units by thermally coupling them to a cooling structure. In some embodiments of the present disclosure, the thermally conductive potting material is also electrically conductive and contributes to electrical management of the one or more energy units by providing a common electrical plane that is shared across the one or more energy units (e.g., which may be coupled in parallel to a busbar).

In accordance with some embodiments of the present disclosure, a battery cell includes a cooling structure, a plurality of energy units thermally coupled to the cooling structure via a first interface, and a thermally conductive potting material that thermally couples the plurality of energy units to each other and to the cooling structure via a second interface.

In some embodiments, the thermally conductive potting material is electrically conductive.

In some embodiments, a thermal conductivity of the thermally conductive potting material is at least 2 W/m*K.

In some embodiments, an adhesive strength of the thermally conductive potting material is at least 10 MPa.

In some embodiments, the plurality of energy units are cylindrical energy units arranged axially in parallel to each other.

In some embodiments, the first interface is between a side of the cooling structure and respective ends of the cylindrical energy units, and the second interface is between the side of the cooling structure and respective cylindrical sides of the energy units.

In some embodiments, the plurality of energy units are electrically coupled in parallel.

In some embodiments, the battery cell also includes a housing having a removable side. In some embodiments, the cooling structure, the plurality of energy units, and the thermally conductive potting material are coupled to the removable side. In some embodiments, the removable side includes two electrical terminals.

In some embodiments, the thermally conductive potting material also couples the plurality of energy units to the cooling structure via the first interface.

In some embodiments, the battery cell also includes an adhesive, different than the thermally conductive potting material, that thermally couples the plurality of energy units to the cooling structure via the first interface.

In accordance with some embodiments of the present disclosure, an apparatus includes a cooling structure, a plurality of energy units, and a thermally and electrically conductive potting material that thermally couples the plurality of energy units to each other and to the cooling structure.

In some embodiments, a thermal conductivity of the thermally and electrically conductive potting material is at least 2 W/m*K.

In some embodiments, an adhesive strength of the thermally and electrically conductive potting material is at least 10 MPa.

In some embodiments, the plurality of energy units are thermally coupled to the cooling structure via a first interface, and the thermally and electrically conductive potting material thermally couples the plurality of energy units to each other and to the cooling structure via a second interface.

In some embodiments, the plurality of energy units are cylindrical energy units arranged axially in parallel to each other.

In some embodiments, the first interface is between a side of the cooling structure and respective ends of the cylindrical energy units, and the second interface is between respective cylindrical sides of the energy units and the side of the cooling structure.

In some embodiments, the thermally and electrically conductive potting material further couples the plurality of energy units to the cooling structure via the first interface.

In some embodiments, the plurality of energy units are electrically coupled in parallel.

Battery cells such as prismatic battery cells may be configured with a housing. The housing may be an enclosure that cannot readily or releasably (e.g., designed for repeated opening and closing) be opened. For example, it may take minutes or hours to open such an enclosure, or it may not even be possible to open such an enclosure without damaging it. Accordingly, such an enclosure does not permit field maintenance of the battery cell (e.g., including maintenance or replacement of components therein) to readily occur. In accordance with some embodiments of the present disclosure, a battery cell is provided with a housing that includes a removable side, which facilitates field maintenance of the battery cell.

In accordance with some embodiments of the present disclosure, a battery cell includes a housing including an opening, a removable side configured to, in an installed position, cover the opening, and at least one energy unit coupled to the removable side such that removal of the removable side causes the at least one energy unit to be removed from the housing.

In some embodiments, in the installed position, the removable side is coupled to the housing and forms a front panel of the housing.

In some embodiments, in the installed position, the removable side covers the opening to form a sealed enclosure around the at least one energy unit.

In some embodiments, the removable side includes at least one thermal vent.

In some embodiments, the removable side includes two electrical terminals coupled to the at least one energy unit.

In some embodiments, the removable side is coupled to a frame member that is configured to, in the installed position, be arranged adjacent to an inner surface of the housing.

In some embodiments, the battery cell also includes one or more snap-fit fasteners configured to couple the frame member to the housing when the removable side is in the installed position, and decouple the frame member from the housing to enable the removable side to be removed from the housing.

In some embodiments, the battery cell also includes one or more fasteners configured to be installed through an external surface of the housing to couple the housing to the frame member.

In some embodiments, the battery cell also includes a frame member including lateral sides, and the one or more fasteners includes a plurality of fasteners configured to be installed through external lateral sides of the housing to couple the housing to the lateral sides of the frame member.

In some embodiments, the lateral sides of the frame member each include a bent edge of the frame member.

In some embodiments, the frame member includes at least one frame member and opposite sides of the housing are bowed out, and the battery cell also includes a plurality of fasteners configured to be installed through an external surface of the housing to couple the opposite sides of the housing to the at least one frame member, wherein coupling the opposite sides of the housing to the at least one frame member causes the opposite sides to flatten out.

In some embodiments, the removable side is coupled to a top frame member and a bottom frame member that are configured to, in the installed position, be arranged adjacent to respective top and bottom inner surfaces of the housing.

In some embodiments, the removable side is coupled to a coolant line.

In some embodiments, the housing includes two openings, wherein in the installed position, the two openings are aligned with respective ends of the coolant line.

In some embodiments, the battery cell also includes an electrical connector, the housing includes a rear opening, and the electrical connector is configured to mate with the rear opening when the removable side is in the installed position.

In accordance with some embodiments of the present disclosure, a method is disclosed for assembling a battery cell with a removable side. The removable side includes a frame member coupled to at least one energy unit, and the method includes inserting the frame member into an opening of a housing such that the removable side forms a front panel of the housing, and coupling the frame member to the housing using at least one fastener.

In some embodiments, the removable side includes a center post, and the method also includes coupling the center post to opposite sides of the housing.

In some embodiments, the opposite sides of the housing are bowed out, and coupling the center post to the opposite side of the housing includes flattening the opposite sides.

In some embodiments, the removable side also includes a gasket, and the gasket forms a seal between the removable side and the opening when the frame member is inserted into the opening of the housing.

In some embodiments, the frame member is a bottom frame member, the removable side also includes a top frame member, and the method also includes coupling the top frame member to the housing using at least one fastener.

Battery cells including multiple energy units may include two busbars, with a first busbar coupled to common negative terminals of the energy units and additional busbars coupled to respective groups of common positive terminals of the energy units. In some implementations, respective ones of the two busbars are arranged on two sides (e.g., opposite sides) of the energy units. However, such an arrangement occupies volume on a side of the energy units that may be otherwise allocated to equipment contributing to thermal management and/or venting of the prismatic battery cell. In some implementations, two busbars are arranged on one side of the energy units. However, such an arrangement may block venting paths of the one or more energy units. In accordance with some embodiments of the present disclosure, a battery cell (e.g., a prismatic battery cell) is provided with stacked electrical conductors (e.g., two electrical conductor layers separated by an insulator layer) that occupy, for example, a desired volume of the battery cell and may provide suitable venting paths for each of the one or more energy units. In some embodiments of the present disclosure, the stacked electrical conductors also provide mechanical alignment and/or support to each of the one or more energy units.

In accordance with some embodiments of the present disclosure, an apparatus includes a first electrical conductor electrically coupled to rim terminals of energy units, where the first electrical conductor includes openings around respective center terminals of the energy units, a second electrical conductor electrically coupled to the center terminals of the energy units through the openings, and an insulator layer arranged between the first and second electrical conductors.

In some embodiments, the second electrical conductor is electrically coupled to the center terminals using a plurality of tabs.

In some embodiments, the second electrical conductor includes a plurality of bar segments, and the plurality of tabs extend from the plurality of bar segments.

In some embodiments, each tab of the plurality of tabs includes a narrow portion forming a fuse.

In some embodiments, the first electrical conductor includes an electrically conductive sheet layer comprising the openings, and a current collector layer including a plurality of bar segments electrically coupled to the electrically conductive sheet layer.

In some embodiments, the first electrical conductor includes a first current collector including a first contact, the second electrical conductor includes a second current collector including a second contact, and the first and second contacts are electrically coupled to respective first and second electrical terminals of a battery cell.

In some embodiments, the first electrical conductor includes a first electrically conductive sheet layer including first openings and a first current collector layer including second openings, the first openings are aligned with the second openings, and each of the aligned first and second openings corresponds to one of the openings of the first electrical conductor.

In some embodiments, the first current collector layer includes weld joint windows, and the first electrically conductive sheet layer is electrically coupled to the rim terminals using weld joints made through the weld joint windows.

In some embodiments, inner edges of the second openings including an electrically insulating dielectric material.

In some embodiments, the first electrical conductor includes a plurality of holes, and the apparatus further includes adhesive applied to the plurality of holes such that the adhesive bonds the first current collector layer to the energy units through the plurality of holes.

In accordance with some embodiments of the present disclosure, an apparatus includes a plurality of energy units, each including an end having a rim terminal, and a first electrical conductor including a plurality of openings, where the first electrical conductor is arranged over the ends of the energy units such that each end extends at least partially into a respective opening, the openings provide a lateral constraint to the ends the energy units, and the first electrical conductor is electrically coupled to the rim terminals.

In some embodiments, the plurality of openings each includes a depth, and the ends of the energy units extend into greater than 50% of the depth of the openings.

In some embodiments, the openings each include a maximum diameter greater than an outer diameter of the energy units, and the openings each include a minimum diameter less than the outer diameter of the energy units.

In some embodiments, the first electrical conductor includes an electrically conductive sheet layer including the minimum diameters, and a current collector layer including the maximum diameters.

In some embodiments, the electrically conductive sheet layer is electrically coupled to the rim terminals.

In some embodiments, the first electrical conductor is electrically coupled to the rim terminals using wire bonds or laser welds.

In some embodiments, the first electrical conductor includes an elongated opening configured to accommodate a center post.

In some embodiments, the end of each energy unit also includes a center terminal, and the apparatus also includes a second electrical conductor that is electrically coupled to the center terminals through the plurality of openings, and an insulator layer arranged between the first and second electrical conductors.

In some embodiments, the second electrical conductor includes a plurality of bar segments, and the bar segments are coupled to the center terminals using a plurality of tabs.

In some embodiments, the plurality of openings includes a plurality of first openings, the second electrical conductor includes a plurality of second openings, and each of the plurality of second openings is concentric with and smaller than a respective one of the plurality of openings.

Battery cells may include multiple pouch energy units, with each pouch having two tabs for its electrical terminals. The tabs generally do not have high rigidity, which leads to difficulty electrically coupling the tabs of adjacent pouch energy units to each other and/or to other electrical connectors. This electrical coupling challenge generally causes increased processing time and/or reduced reliability of the battery cell. In accordance with some embodiments of the present disclosure, a battery cell is provided with multiple pouch energy units, each having bent tabs, which are electrically coupled to current collectors behind the bent tab, which permits reduced manufacturing time and/or more secure electrical connections.

In accordance with some embodiments of the present disclosure, an apparatus includes a plurality of pouch energy units including a plurality of electrical tabs, each having a bent end, and a current collector arranged across the plurality of pouch energy units, where the current collector includes a plurality of tines extending behind the bent ends, and each bent end is electrically coupled to a corresponding tine.

In some embodiments, the plurality of electrical tabs each comprise a first end portion extending outward from a respective pouch energy unit and a second end portion comprising the bent end, and the bent end is approximately perpendicular to the first end portion. In some embodiments, the plurality of electrical tabs each includes a middle portion between the first end portion and the second end portion, and the middle portion includes a curve or one or more bends. In some embodiments, the middle portion includes two approximately 45 degree bends.

In some embodiments, the plurality of electrical tabs includes first and second subgroups, the first subgroup is adjacent to the second subgroup, the bent ends of the first subgroup are angled towards the second subgroup, and the bent ends of the second subgroup are angled towards the first subgroup.

In some embodiments, the apparatus also includes a center post positioned between the pouch energy units corresponding to the first and second subgroups.

In some embodiments, each bent end includes a first surface and an opposite second surface contacting the corresponding tine, and each bent end is electrically coupled to the corresponding tine from a weld performed on the first surface.

In some embodiments, the plurality of electrical tabs includes a plurality of first electrical tabs and the current collector includes a first current collector having a plurality of first tines. The apparatus also includes a plurality of second electrical tabs, each including a bent end, a second current collector arranged across the plurality of second electrical tabs, where the second current collector includes a plurality of second tines extending behind the bent ends of the second electrical tabs, and each bent end of the second electrical tabs is electrically coupled to a corresponding second tine.

In some embodiments, the first and second tines are oriented towards each other.

In some embodiments, the first electrical tabs are of a first polarity and the second electrical tabs are of a second polarity opposite the first polarity.

In some embodiments, the first and second current collectors are coupled to respective first and second terminals of a battery cell.

In accordance with some embodiments of the present disclosure, a method is provided for electrically connecting a plurality of energy units including a plurality of electrical tabs in parallel. The method includes aligning the plurality of electrical tabs using a guide fixture, inserting tines of a current collector behind the aligned electrical tabs, and welding bent ends of the plurality of electrical tabs to corresponding tines of the current collector.

In some embodiments, the aligning includes moving the three-dimensional fixture towards the plurality of electrical tabs such that the electrical tabs are inserted in openings of the guide fixture.

In some embodiments, the guide fixture forms the bent ends.

In some embodiments, the guide fixture includes first and second subgroups of the openings, the first subgroup of openings causes the inserted electrical tabs to bend towards the second subgroup, and the second subgroup of openings causes the inserted electrical tabs to bend towards the first subgroup.

In some embodiments, the method also includes removing the guide fixture from a first side of the plurality of electrical tabs while the tines are inserted from a second side opposite the first side.

In some embodiments, the method also includes pressing the bent ends against the tines prior to welding using a pressing fixture comprising a plurality of openings.

In some embodiments, the welding is performed through the openings, and the method also includes removing the pressing fixture after welding.

In some embodiments, the plurality of electrical tabs includes a plurality of first electrical tabs, the guide fixture includes a first guide fixture, and the current collector includes a first current collector comprising a plurality of first tines. The method also includes aligning the plurality of second electrical tabs using a second guide fixture, inserting the second tines of the second current collector behind the aligned second electrical tab, and welding bent ends of the plurality of second electrical tabs to corresponding second tines of the second current collector.

In some embodiments, the first tines are inserted behind the aligned first electrical tabs in a first direction, and the second tines are inserted behind the aligned second electrical tabs in a second direction opposite the first direction.

Battery cells such as prismatic battery cells may include a venting structure for venting outgas (e.g., a gas that is released from inside an energy unit) out of a housing of the prismatic battery cell. In some embodiments, the venting structure does not directly couple to respective vents of each of the multiple energy units. Such a venting structure may not protect non-venting energy units when an energy unit vents an outgas. In accordance with some embodiments of the present disclosure, a battery cell includes a plate coupled to a venting structure. Openings in the plate are coupled to respective vents of energy units and a passageway in the plate is coupled to the venting structure, which may protect non-venting energy units when one energy unit vents an outgas.

In accordance with some embodiments of the present disclosure, a battery cell includes an exhaust plate including first and second sides and a passageway therebetween, a plurality of energy units, each including a vent at an end, where the ends of a first subset of the energy units are affixed to the first side, the ends of a second subset of the energy units are affixed to the second side, and the vents of the energy units are configured to vent into the passageway, and a vent structure coupled to the passageway and configured to cause gas released from one or more of the energy units to vent out of the battery cell.

In some embodiments, a first end of the vent structure is coupled to the exhaust plate and a second end of the vent structure has an opening vented outside of the battery cell.

In some embodiments, the exhaust plate extends from a first side of the battery cell to a second side of the battery cell.

In some embodiments, each vent is configured to release gas into the exhaust plate in response to a pressure of the respective energy unit exceeding a threshold.

In some embodiments, a composite yield strength of the exhaust plate is at least 100 MPa.

In some embodiments, the energy units each include first and second electric terminals on an end opposite the end including the vent.

In some embodiments, the battery cell is configured to be cooled by a liquid dielectric coolant that surrounds the plurality of energy units, such that the energy units are submerged in the liquid dielectric coolant.

In some embodiments, the liquid dielectric coolant is configured to enter the battery cell via an inlet port and exit via an outlet port, and the ends of the energy units are affixed to the exhaust plate such that the vents are sealed from the liquid dielectric coolant.

In some embodiments, the exhaust plate includes a middle layer arranged between the first side and the second side. In some embodiments, the middle layer divides the passageway into two regions, and the middle layer includes at least one opening between the two regions. In some embodiments, the at least one opening includes a plurality of openings, the plurality of openings including a primary exhaust path opening aligned with the vent structure, and a plurality of secondary exhaust holes spaced apart from the primary exhaust path opening. In some embodiments, the plurality of secondary exhaust holes are arranged laterally away from the ends of the energy units.

In some embodiments, the vent structure includes a burst disc.

In accordance with some embodiments of the present disclosure, an apparatus includes an exhaust plate including first and second sides, each of the first and second sides configured to receive a gas, and a passageway therebetween, and a vent structure coupled to the passageway and configured to cause the gas to release outside of the housing.

In some embodiments, the apparatus also includes a plurality of energy units, each comprising a vent at an end, where the ends of a first subset of the energy units are affixed to the first side, the ends of a second subset of the energy units are affixed to the second side, and the vents of the energy units are configured to vent into the passageway.

In some embodiments, a composite yield strength of the exhaust plate is at least 100 MPa.

In some embodiments, the exhaust plate includes a middle layer arranged between the first side and the second side. In some embodiments, the middle layer divides the passageway into two regions, and the middle layer includes at least one opening between the two regions. In some embodiments, the at least one opening includes a plurality of openings, the plurality of openings including a primary exhaust path opening aligned with the vent structure, and a plurality of secondary exhaust holes spaced apart from the primary exhaust path opening.

In accordance with some embodiments of the present disclosure, a method for assembling a battery cell includes affixing ends of a first subset of a plurality of energy units to a first side of an exhaust plate, and affixing ends of a second subset of the plurality of energy units to a second side of the exhaust plate, where the exhaust plate includes a passageway between the first and second sides, the ends of the plurality of energy units each include a vent, the vents are configured to vent gas into the passageway, and the passageway and a vent structure are configured to directed vented gas out of the battery cell.

It is noted that the present disclosure, including the abovementioned embodiments of the present disclosure, describes various aspects of battery cells. These aspects may be independently implemented, or multiple of these aspects may be implemented together. In some embodiments, these aspects may apply to prismatic battery cells having cylindrical energy units, pouch energy units, or any other suitable energy units. These prismatic battery cells may have multiple energy units, and all of these multiple energy units may be electrically coupled in parallel (e.g., there may not be any two energy units that are coupled in series inside the housing).

Embodiments of the present disclosure may provide battery cells (e.g., prismatic battery cells) that are suitable for serving applications including, but not limited to, grid-scale energy storage, electric mobility, indoor energy storage, uninterruptible power supplies, backup on-site power, and energy storage co-located with solar, wind, or other intermittent energy generation. Embodiments of the present disclosure may also provide battery cells (e.g., prismatic battery cells) that are modular and readily serviceable.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows a first type of prismatic battery cell and its internal components, in accordance with some embodiments of the present disclosure;

FIG. 2 shows an exterior view of a prismatic battery cell, in accordance with some embodiments of the present disclosure;

FIG. 3 shows a center post and a corresponding fastening arrangement for the first type of prismatic battery cell, in accordance with some embodiments of the present disclosure;

FIG. 4 shows a modified first type of prismatic battery cell with a greater density of energy units, in accordance with some embodiments of the present disclosure;

FIG. 5 shows a first modified center post and a corresponding fastening arrangement, in accordance with some embodiments of the present disclosure;

FIG. 6 shows a modified second type of prismatic battery cell with a greater density of energy units, in accordance with some embodiments of the present disclosure;

FIG. 7 shows a second modified center post and a corresponding fastening arrangement, in accordance with some embodiments of the present disclosure;

FIG. 8 shows a block diagram of a battery cooling system, in accordance with some embodiments of the present disclosure;

FIG. 9A shows a front view of a second type of prismatic battery cell and its internal components, in accordance with some embodiments of the present disclosure;

FIG. 9B shows a rear view of the second type of prismatic battery cell and its internal components, in accordance with some embodiments of the present disclosure;

FIG. 10A shows a front view of cooling equipment of the second type of prismatic battery cell, in accordance with some embodiments of the present disclosure;

FIG. 10B shows a rear view of cooling equipment of the second type of prismatic battery cell, in accordance with some embodiments of the present disclosure;

FIG. 11 shows a top view of coolant flow through the second type of prismatic battery cell, in accordance with some embodiments of the present disclosure;

FIG. 12 shows a top view of coolant flow through the first type of prismatic battery cell, in accordance with some embodiments of the present disclosure;

FIG. 13 shows cooling sockets, in accordance with some embodiments of the present disclosure;

FIG. 14 shows an exploded view of a cooling structure, in accordance with some embodiments of the present disclosure;

FIG. 15 shows a coolant fluid flow path, in accordance with some embodiments of the present disclosure;

FIG. 16 shows coolant flow through the third type of prismatic battery cell, in accordance with some embodiments of the present disclosure;

FIG. 17 shows a cooling system coupled a prismatic battery cell with a single coolant line, in accordance with some embodiments of the present disclosure;

FIG. 18 shows thermally conductive potting material of the first type of prismatic battery cell, in accordance with some embodiments of the present disclosure;

FIG. 19 shows a sequence for assembling a portion of the first type of prismatic battery cell, in accordance with some embodiments of the present disclosure;

FIG. 20 shows thermal interfaces of a thermally conductive potting material, in accordance with some embodiments of the present disclosure;

FIG. 21A shows a first coupling between a housing with an opening and a removable side configured to cover the opening, in accordance with some embodiments of the present disclosure;

FIG. 21B shows an interface between the housing and the removable side, in accordance with some embodiments of the present disclosure;

FIG. 22 shows a battery cell with bowed out sides, before and after fastening, in accordance with some embodiments of the present disclosure;

FIG. 23 shows a second coupling between a housing with an opening and a removable side, in accordance with some embodiments of the present disclosure;

FIG. 24 shows a third coupling between a housing with an opening and a removable side, in accordance with some embodiments of the present disclosure;

FIG. 25 shows a first approach for fastening and/or insulating a removable side, in accordance with some embodiments of the present disclosure;

FIG. 26 shows a second approach for fastening and/or insulating a removable side, in accordance with some embodiments of the present disclosure;

FIG. 27 shows a coupling between an electrical connector of a removable side and a housing, in accordance with some embodiments of the present disclosure;

FIG. 28 shows a coupled interface including a snap-fit fastener, in accordance with some embodiments of the present disclosure;

FIG. 29 shows a method for assembling a battery cell with a removable side, in accordance with some embodiments of the present disclosure;

FIG. 30 shows a first approach for electrically coupling to a plurality of energy units, in accordance with some embodiments of the present disclosure;

FIG. 31 shows an assembly flow for the first approach for electrically coupling to a plurality of energy units, in accordance with some embodiments of the present disclosure;

FIG. 32 shows electrical coupling tabs without fuses, in accordance with some embodiments of the present disclosure;

FIG. 33 shows electrical coupling tabs with fuses, in accordance with some embodiments of the present disclosure;

FIG. 34A shows a first approach for mechanically aligning a plurality of energy units via an electrical conductor, in accordance with some embodiments of the present disclosure;

FIG. 34B shows a second approach for mechanically aligning a plurality of energy units via an electrical conductor, in accordance with some embodiments of the present disclosure;

FIG. 35 shows a second approach for electrically coupling to a plurality of energy units, in accordance with some embodiments of the present disclosure;

FIG. 36 shows a thermal runaway path associated with the second approach for electrically connecting to a plurality of energy units, in accordance with some embodiments of the present disclosure;

FIG. 37 shows a third approach for electrically coupling to a plurality of energy units, in accordance with some embodiments of the present disclosure;

FIG. 38 shows a fourth approach for electrically coupling to a plurality of energy units, in accordance with some embodiments of the present disclosure;

FIG. 39 shows various aspects of the fourth approach for electrically coupling to a plurality of energy units, in accordance with some embodiments of the present disclosure;

FIG. 40 shows a first partial assembly flow associated with the fourth approach for electrically coupling to a plurality of energy units, in accordance with some embodiments of the present disclosure;

FIG. 41 shows guide fixtures used in connection with the assembly flow associated with the fourth approach for electrically coupling to a plurality of energy units, in accordance with some embodiments of the present disclosure;

FIG. 42 shows additional details of the guide fixtures, in accordance with some embodiments of the present disclosure;

FIG. 43 shows pressing fixtures used in connection with the assembly flow associated with the fourth approach for electrically coupling to a plurality of energy units, in accordance with some embodiments of the present disclosure;

FIG. 44 shows a second partial assembly flow associated with the fourth approach for electrically coupling to a plurality of energy units, in accordance with some embodiments of the present disclosure;

FIG. 45 shows a method for electrically coupling bent ends of a plurality of electrical tabs to a current collector, in accordance with some embodiments of the present disclosure;

FIG. 46A shows a front view of a third type of prismatic battery cell and its internal components, in accordance with some embodiments of the present disclosure;

FIG. 46B shows a rear view of the third type of prismatic battery cell and its internal components, in accordance with some embodiments of the present disclosure;

FIG. 47 shows energy unit interfaces associated with the third type of prismatic battery cell, in accordance with some embodiments of the present disclosure;

FIG. 48 shows an exhaust plate, in accordance with some embodiments of the present disclosure;

FIG. 49 shows an exhaust path through the exhaust plate, in accordance with some embodiments of the present disclosure;

FIG. 50, shows a cross-sectional view of the exhaust plate and multiple energy units coupled to the exhaust plate, in accordance with some embodiments of the present disclosure;

FIG. 51, shows a middle layer of the exhaust plate, in accordance with some embodiments of the present disclosure; and

FIG. 52, shows a method for coupling a plurality of energy units to an exhaust plate, in accordance with some embodiments of the present disclosure.

### DETAILED DESCRIPTION

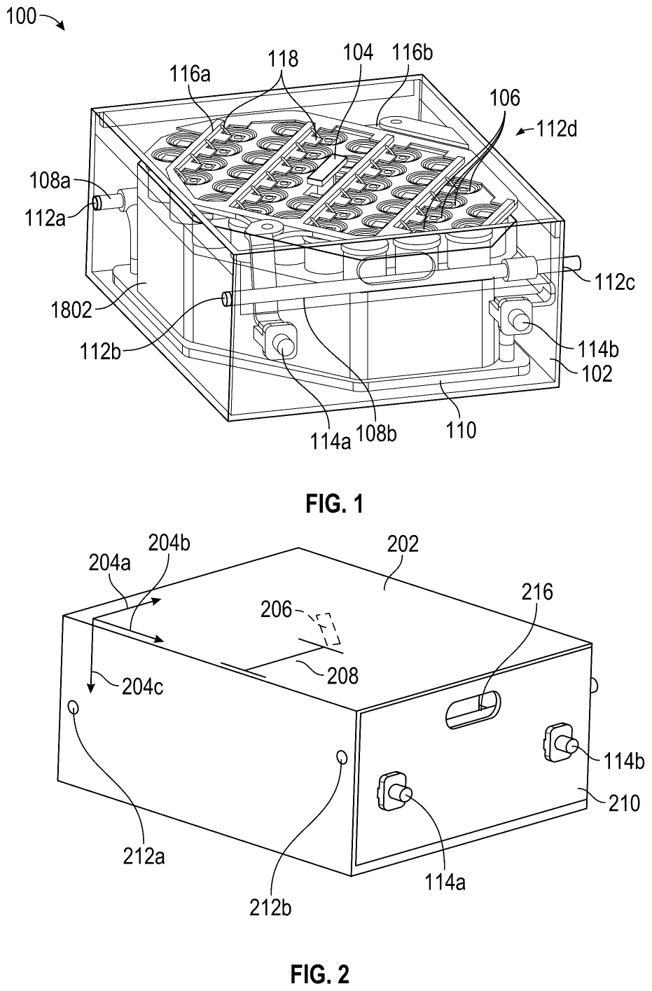

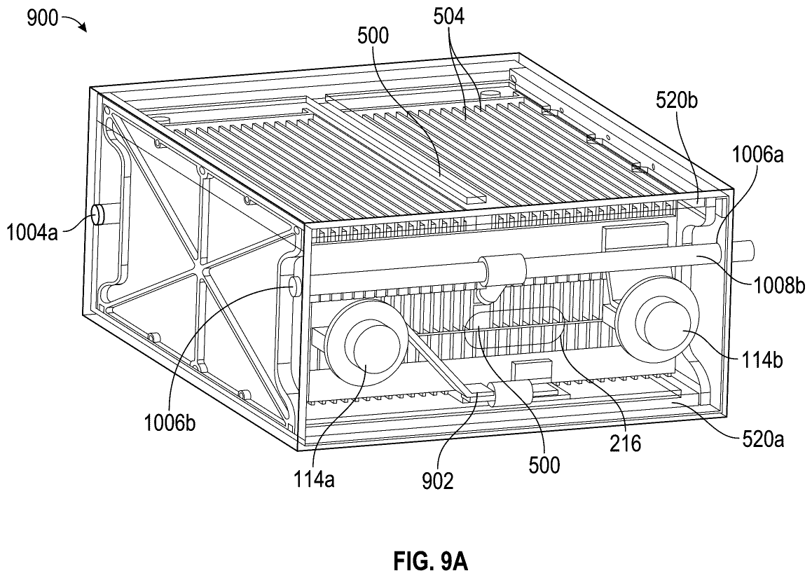

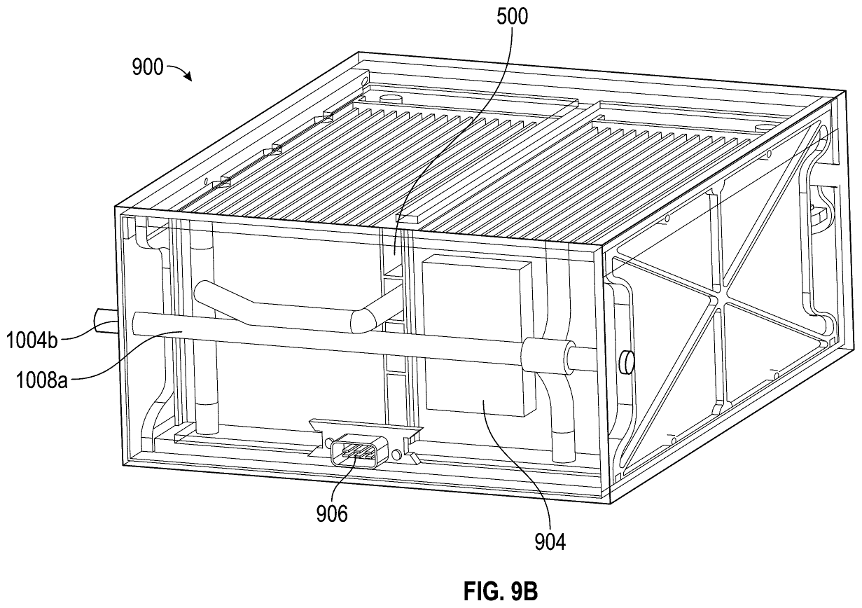

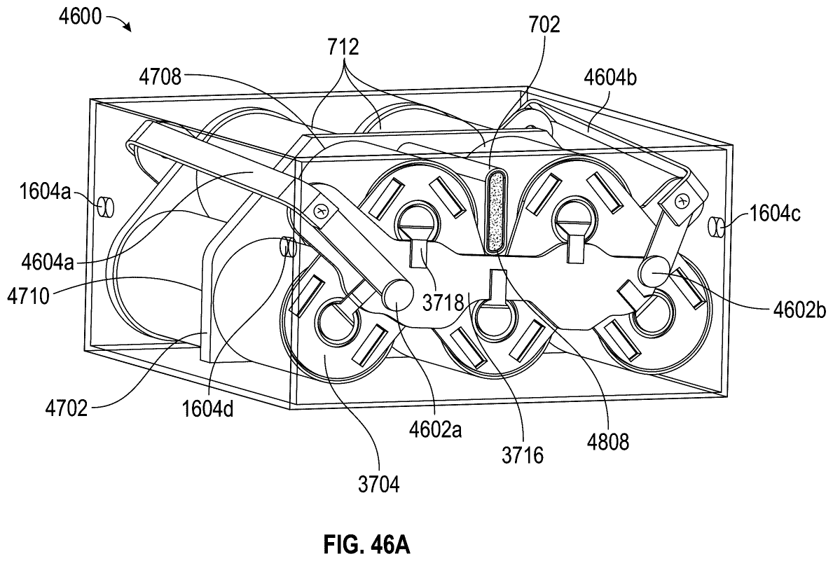

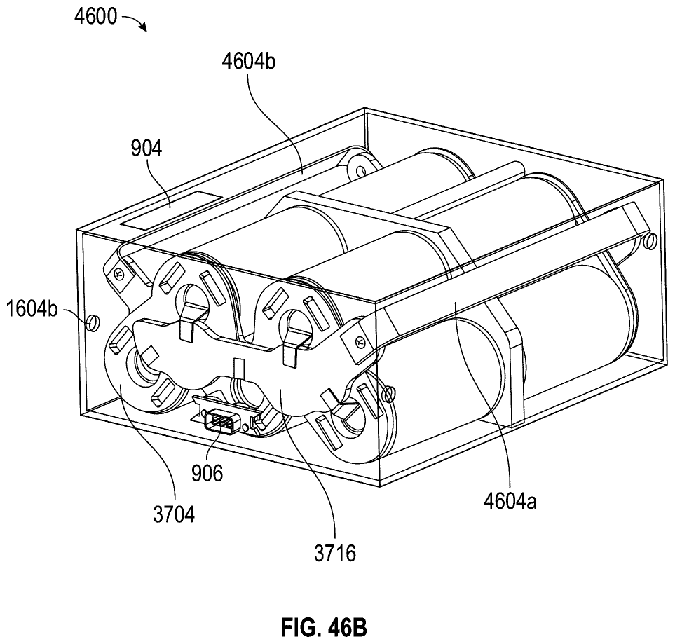

It is noted that multiple illustrative types of prismatic battery cells are disclosed in the drawings, including, for example, a first type of prismatic battery cell 100 (e.g., as shown in FIG. 1 and elsewhere) having cylindrical energy units, a second type of prismatic battery cell 900 (e.g., as shown in FIG. 9 and elsewhere) having pouch energy units, and a third type of prismatic battery cell 4600 (e.g., as shown in FIG. 46 and elsewhere) having an internal venting structure. The multiple illustrative types of prismatic battery cells are shown in a variety of depictions (e.g., as fully constructed in some embodiments, with transparent housing, with illustrative annotations, with selected components removed to better illustrate other components, with selective components exploded or highlighted to better illustrate these components, or to otherwise better illustrate various embodiments of the present disclosure) and in different configurations. These illustrative types of prismatic battery cells share many features, while also having properties that are distinct with respect to the others.

FIG. 1 shows a first type of prismatic battery cell 100 and its internal components, in accordance with some embodiments of the present disclosure. The prismatic battery cell 100 includes housing 102, which is shown as transparent in FIG. 1 to illustrate components of prismatic battery cell 100 that are enclosed within housing 102. Housing 102 encloses center post 104, multiple energy units 106, at least a portion of each of coolant lines 108a and 108b, and cooling structure 110. Coolant ports 112a, 112b, 112c, and 112d (which, despite being obscured due to the perspective view of FIG. 1, is opposite coolant port 112a) are in housing 102 such that coolant lines 108a and 108b may extend out to other cooling equipment (e.g., one or more additional prismatic battery cells, cooling system 802, or any combination thereof).

In some embodiments, all of the multiple energy units 106 are electrically coupled in parallel. In other words, no two of the multiple energy units 106 are coupled in series. Thus, prismatic battery cell terminals 114a and 114b may electrically couple to positive and negative (or vice versa) unit terminals, respectively, of each of the multiple energy units 106 within housing 102. In some embodiments, electrical conductors 116a and 116b provide electrical contact (e.g., via wire bonds or tabs 118) to respective unit terminals of the multiple energy units 106 and to the respective battery cell terminals 114a and 114b. Based on this electrical connection arrangement, the multiple energy units function as a single energy unit and each of the multiple energy units provides an output voltage that corresponds to an output voltage of the prismatic battery cell. In some embodiments, the output voltage of the prismatic battery cell is electrically coupled to a load (e.g., via a battery management system or other suitable controller or via electrical contacts).

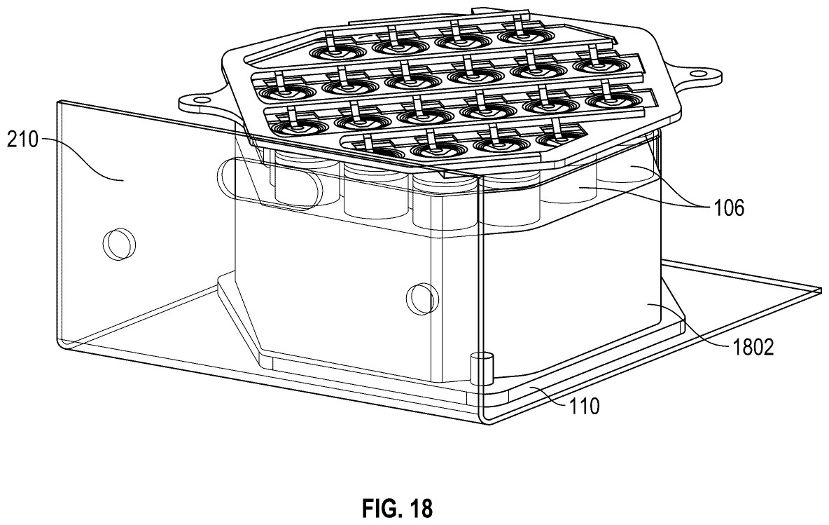

In some embodiments, the first type of prismatic battery cell 100 also includes thermally conductive potting material 1802 (e.g., as described at least in connection with FIG. 18), battery passport 904 and electrical output connector 906 (e.g., as described below at least in connection with FIG. 9B). For example, electrical output connector 906 may be included on the panel behind first coolant line 108a, and battery passport 904 may be included in the back-right corner (e.g., as is obstructed in the perspective view of FIG. 1) of the housing.

FIG. 2 shows an exterior view of a prismatic battery cell (e.g., prismatic battery cell 100), in accordance with some embodiments of the present disclosure. The prismatic battery cell includes housing 202, which defines an internal volume of the prismatic battery cell. The internal volume is equal to a size of housing 202 along the first dimension 204a (e.g., a width of housing 202), multiplied by a size of housing 202 along the second dimension 204b (e.g., a length of housing 202), multiplied by a size of housing 202 along the third dimension 204c (e.g., a height of housing 202).

In some embodiments, a smallest dimension component of the prismatic battery cell (e.g., prismatic battery cell 100, prismatic battery cell 900, or prismatic battery cell 4600) is along the third dimension 204c. The sides of the housing 202 that are spaced apart by the third dimension 204c (e.g., the smallest dimension component) may be first and second sides of the housing. In some embodiments, center post 206 (or any other suitable center post, including that shown in connection with prismatic battery cell 100, prismatic battery cell 900, or prismatic battery cell 4600) is coupled between the first side (e.g., the side on which the center post 206 footprint is annotated in dashed lines) of the housing 202 and the second side of the housing 202 (e.g., the side opposite the first side). In some embodiments, the smallest dimension component corresponds to an axis (e.g., the axis being parallel to or overlapping with third dimension 204c, as annotated), and the center post 206 is parallel to the axis.

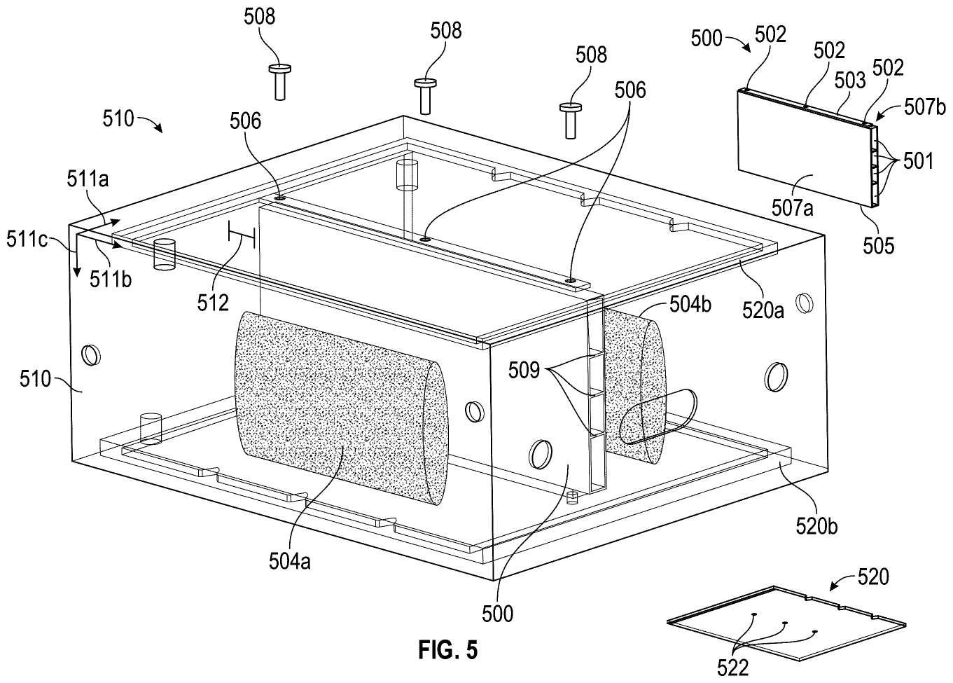

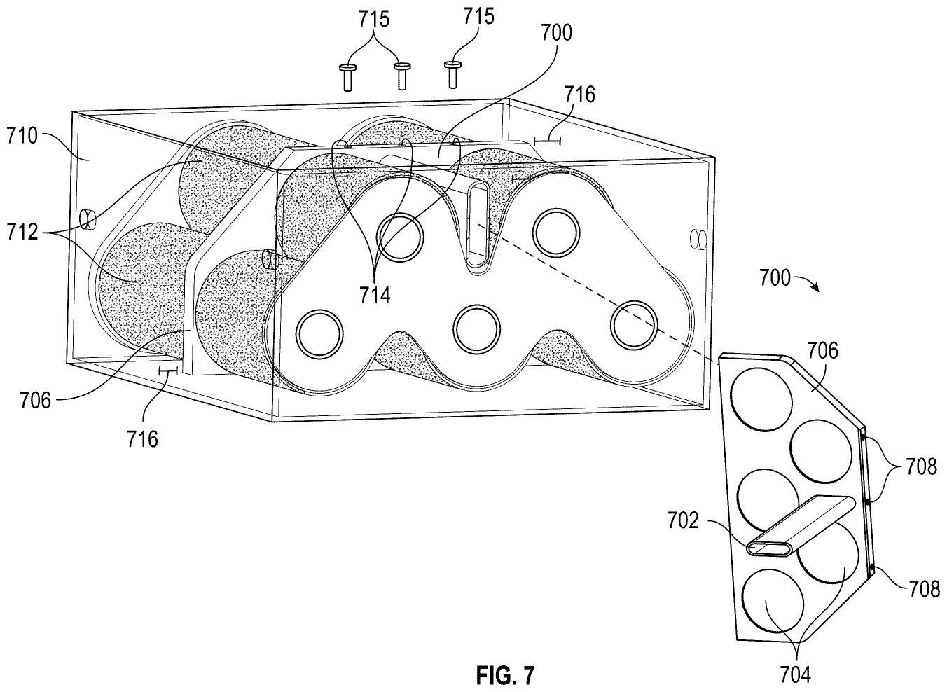

In some embodiments, the center post 206 spans respective regions of the first and second sides of housing 202, and the respective regions do not extend to any edges of the first and second sides of housing 202. For example, a clearance 208 may be provided between an edge of center post 206 and an edge of the first and second sides of housing 202. It is noted that while clearance 208 (and other clearances, e.g., clearance 512 of FIG. 5 and clearance 716 of FIG. 7) is only shown between one edge of center post 206 and one edge of a side of housing 202, a similar clearance 208 may exist between any edge of center post 206 and any edge of the first and second sides of housing 202.

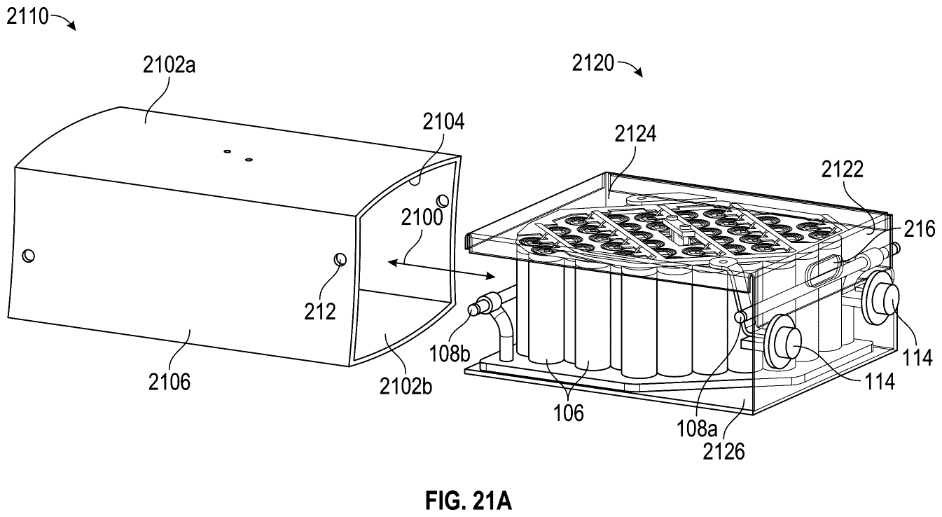

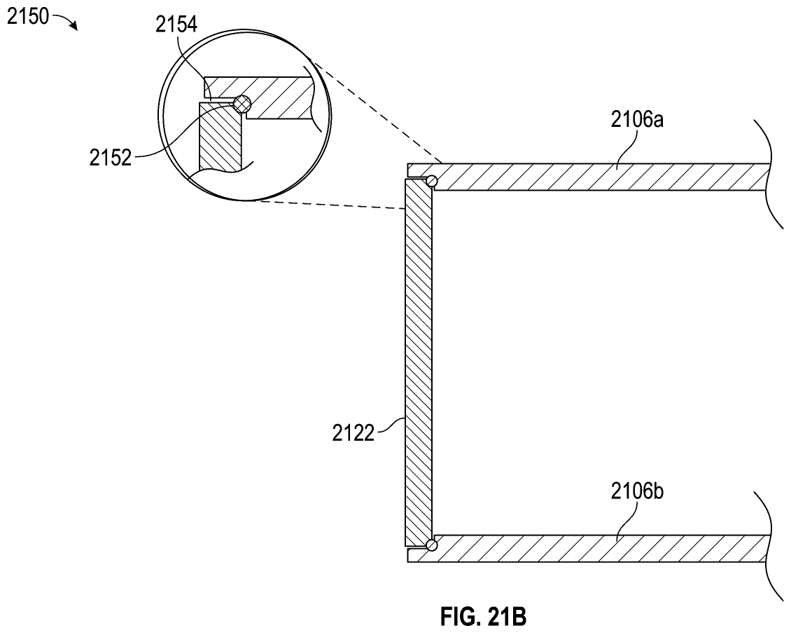

In some embodiments, a front panel of housing 202 is removable. To illustrate, removable front panel 210 is in an installed position as shown in FIG. 2, in which the housing 202 is a sealed enclosure. Removable front panel 210 may be removed and is shown in an uninstalled position, e.g., in connection with FIGS. 21, 23, 24, and 28, in which housing 202 has five connected sides. In some embodiments, the removable front panel of housing 202 includes electrical terminals (e.g., battery cell terminals 114a and 114b). In some embodiments, the removable front panel (e.g., the removable side) of housing 202 is parallel to the smallest dimension component of the housing.

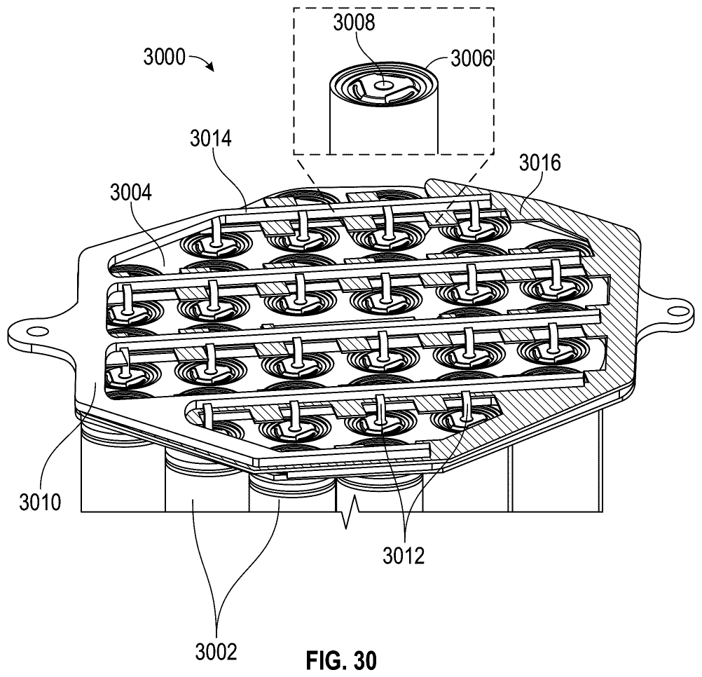

In some embodiments, the removable front panel 210 includes thermal vent 216 and battery cell terminals 114. Thermal vent 216 provides a pathway for a gas released from any one or more of the energy units (e.g., energy units 106 or energy units 504) to vent out of housing 202 (e.g., to minimize heating or other exposure of other energy units to the gas). Battery cell terminals 114 provide for connections to positive and negative terminals of one or more energy units (e.g., energy units 106 or energy units 504), which can be connected in parallel as further described below (e.g., at least in connection with FIGS. 30-31, 35, and 37). In some embodiments, the housing 202 of prismatic battery cell 100 also includes coolant ports 212, as further described below (e.g., at least in connection with FIGS. 9-13, 15, and 21).

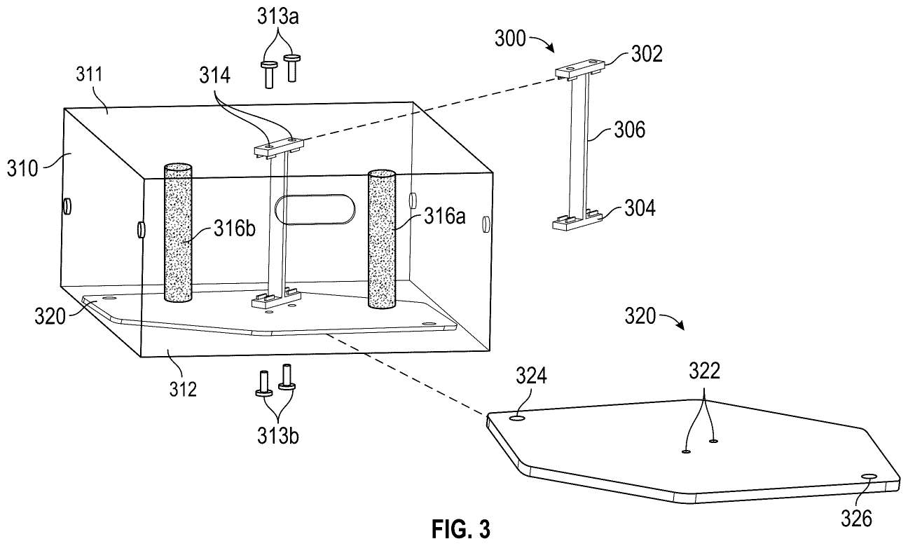

FIG. 3 shows center post 300 and a corresponding fastening arrangement, in accordance with some embodiments of the present disclosure. In some embodiments, center post 300 corresponds to center post 104. Center post 300 includes first end plate 302 (e.g., for mechanically coupling to a first side of a prismatic battery cell), second end plate 304 (e.g., for mechanically coupling to a second side of a prismatic battery cell), and rod 306 connecting the first and second end plates. In some embodiments, the first end plate 302 has a rectangular shape and is affixed to the housing first side 311 (e.g., such that it spans a center portion of the housing first side without contacting any edge of the housing first side) and the second end 304 plate has a rectangular shape and is affixed to the housing second side 312 (e.g., such that it spans a center portion of the housing second side without contacting any edge of the housing second side). In some embodiments, housing first side 311 and housing second side 312 may respectively correspond to the first side of housing 202 and the second side of housing 202 (as described in connection with FIG. 2). The center post 300 may be affixed to housing first side 311 and housing second side 312 by fasteners 313a and fasteners 313b, respectively. Accordingly, housing first side 311 may include fastener holes 314, and housing second side 312 may include corresponding fastener holes. In some embodiments, the corresponding fastener holes of housing second side 312 may be aligned with the fastener holes 322 of cooling structure 320, as described below.

As shown at least in FIG. 1 and FIG. 3, a prismatic battery cell may include a cooling structure (e.g., cooling structure 320) that is thermally coupled to multiple energy units (e.g., multiple energy units 106 or energy units 316a and 316b). In some embodiments, cooling structure 320 corresponds to cooling structure 110, any of cooling structures 821, or cooling structure 1210. As shown, cooling structure 320 is arranged between second end plate 304 of center post 300 and housing second side 312. As such, cooling structure 320 may include fastener holes 322, such that fasteners 313b may affix center post 300 to housing 310 (specifically, housing second side 312). Thus, one end of the center post 300 (e.g., second end plate 304) may be mechanically coupled to the first side of housing 310 via the cooling structure 320. Fasteners 313b may be similar to fasteners 313a, although the length of the former may be greater by an amount corresponding to the thickness of cooling structure 320.

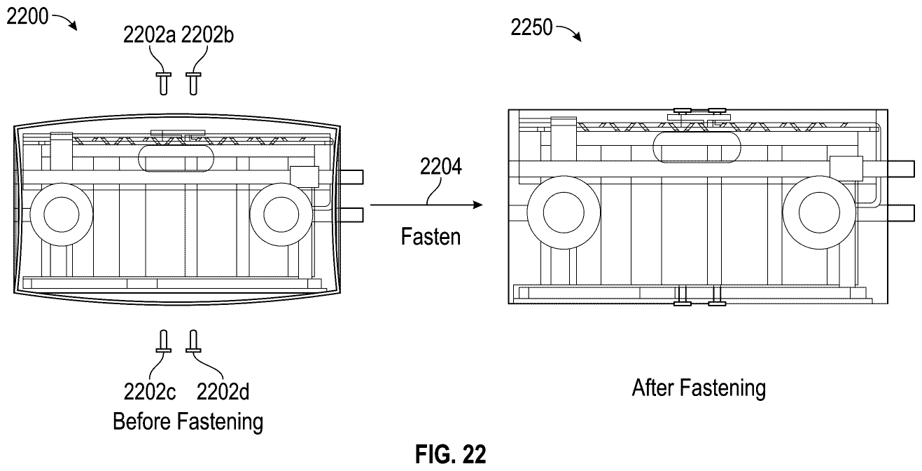

In some embodiments, the first and second sides of the housing (e.g., housing first side 311 and housing second side 312, respectively) each have a bowed out shape (e.g., as shown at least in FIGS. 21-23). As further described in connection with at least FIGS. 21-23, applying fasteners (e.g., fasteners 313a and/or 313b) to affix a center post (e.g., center post 300) to bowed out sides of a housing may cause the bowed out sides to flatten out. In some embodiments, the housing includes a removable side (e.g., removable front panel 210) mechanically coupled to the center post (e.g., center post 104, 206, or 300), and the bowed out shape of the first and second sides provide a clearance for the center post when the removable side is removed from the housing. For example, the center post (e.g., center post 300) may be affixed to the removable side (e.g., removable front panel 210) via cooling structure 320 (which may be directly affixed to the removable side or a frame member of the removable side, e.g., as shown and described at least in connection with FIG. 21A). Based on these connections, center post 300 may have access to the housing (e.g., housing 310) through the clearance of the bowed out side when positioning the removable front panel to seal the opening in the housing. After positioning the removable side and the center post within the housing, the bowed out side may be flattened by applying fasteners 313a (e.g., as shown and described at least in connection with FIG. 22).

In some embodiments (e.g., as shown at least in FIG. 1, FIG. 3, and FIG. 7), the prismatic battery cell (e.g., prismatic battery cell 100, prismatic battery cell 900, or prismatic battery cell 4600) includes a plurality of energy units, and the plurality of energy units surround the center post. For example, energy units 316a and 316b are on either side of center post 300 and thus surround center post 300. In some embodiments, energy units 316 correspond to energy units 106.

In accordance with some embodiments of the present disclosure, the center post provides mechanical support to the housing of a prismatic battery cell. In some embodiments, the center post has a yield strength of at least 20, 40, 60, 80 100, 120, 140, 160, 180, or 200 MPa. In response to a mechanical force acting along the direction of center post rod 306, such as an external force pushing inward on a face of housing 310 or an internal force (e.g., an outgas) pushing outward on a face of housing 310, center post 300 may prevent or mitigate deformation of the housing 310.

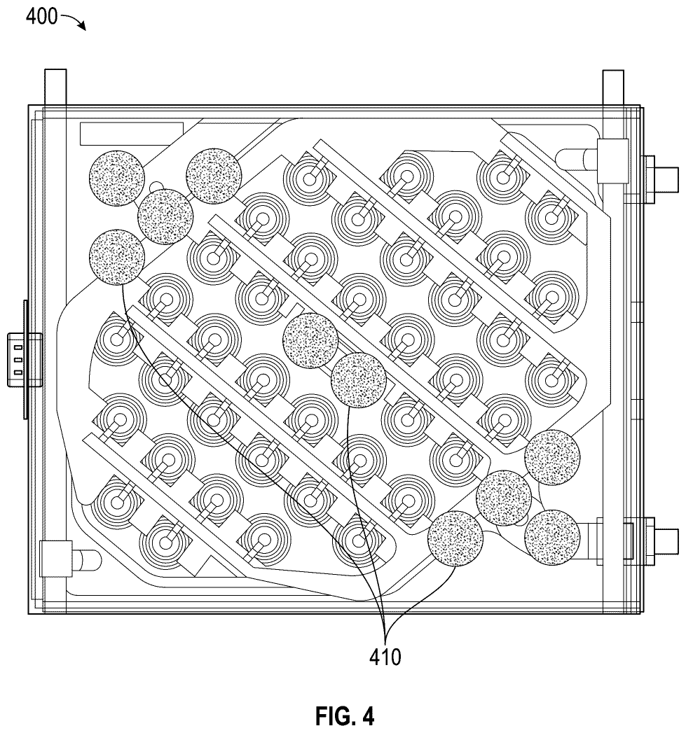

FIG. 4 shows a modified first prismatic battery cell 400 with a greater density of energy units, in accordance with some embodiments of the present disclosure. Compared to the prismatic battery cell 100, the modified first prismatic battery cell 400 includes additional energy units 410. These additional energy units 410 may occupy the top-left and bottom-right corners (e.g., regions occupied at least by electrical connectors of prismatic battery cell 100) of modified first prismatic battery cell 400 and/or they may occupy the center (e.g., the region occupied by center post 104 of prismatic battery cell 100) of the modified first prismatic battery cell, as shown in FIG. 4. It is noted that modified first prismatic battery cell 400 may include a center post (e.g., center post 104, center post 206, center post 300, or any other suitable center post) and the subset of additional energy units 410 that do not occupy the center region occupied by the center post.

FIG. 5 shows a first modified center post 500 and a corresponding fastening arrangement, in accordance with some embodiments of the present disclosure. In contrast to being configured for use with cylindrical energy units (e.g., of FIGS. 1, 3, and 4), the prismatic battery cell of FIG. 5, including modified center post 500, are configured for use with energy units 504a and 504b (e.g., pouch energy units). Fastener holes 506 are configured to affix center post 500 to housing 510 via fasteners 508, which may pass through cooling structures 520a and 520b.

In some embodiments, center post 500 is arranged to have a clearance 512 (e.g., similar to clearance 208) between the edge of the center post 500 and the edge of any side of housing 510. Thus, center post 500 may be arranged in a center region of housing 510 that does not extend to any edge of housing 510. Moreover, center post 500 may be configured to span a smallest dimension component (e.g., third dimension 511c) of housing 510, and a length of center post 500 may be configured parallel to an axis corresponding to the smallest dimension component (e.g., center post 500 is arranged similar to the arrangement described at least in connection with FIG. 2).

As shown in FIG. 5, center post 500 may include openings 501 and fastener holes 502. The openings 501 may be arranged parallel to second dimension 511b component of housing 510. As further shown at least in connection with FIGS. 9-11, at least one of the openings 501 may provide a pathway for routing a coolant line or other suitable component of the prismatic battery cell. Fasteners holes 502 may correspond to fastener holes 506, each of which may further correspond to fastener holes 522 in cooling structure 520, such that fasteners 508 may affix center post 500 to housing 510 through cooling structure 520.

Center post 500 may include a first end plate 503 (e.g., for mechanical coupling to a top side of housing 510), second end plate 505 (e.g., for mechanical coupling to a bottom side of housing 510), and sides 507a and 507b (e.g., for connecting the first end plate and the second end plate, while providing at least one of the openings 501). Center post 500 may also include additional intermediate plates 509, as are arranged between and parallel to the first end plate 503 and the second end plate 505, to provide for routing of cooling lines, electrical lines, thermal vents, or other suitable components of the prismatic battery cell, as mentioned above and as further mentioned below.

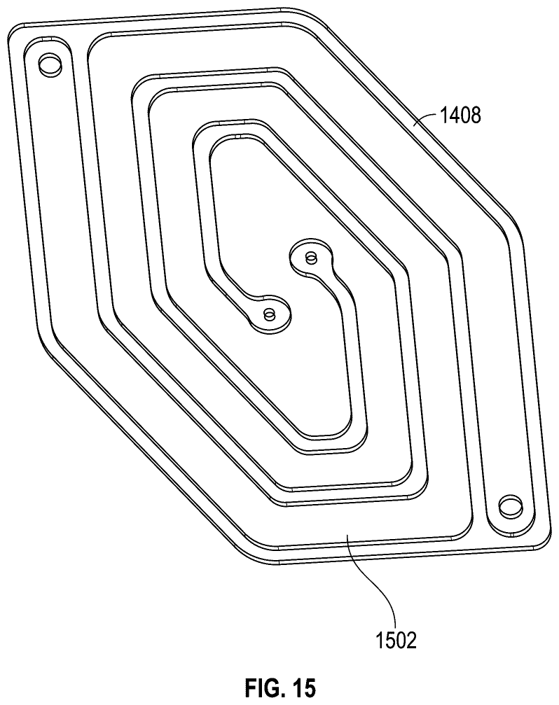

Based on the geometry and electrical interfaces of a pouch energy unit (e.g., energy unit 504a and 504b), the prismatic battery cell of FIG. 5 may include two cooling structures 520 (namely, cooling structures 520a and 520b), each of which is thermally coupled to each of multiple pouch energy units. Cooling structure 520 may have a similar stacked arrangement and fluid path to that of cooling structure 320 (e.g., as further shown in FIG. 15), albeit with a different geometry based on the footprint of the pouch energy units.

It is noted that, in some embodiments, FIG. 5 shows a portion of the second type of prismatic battery cell 900 of FIG. 9 with various components removed to better illustrate at least the center post 500.

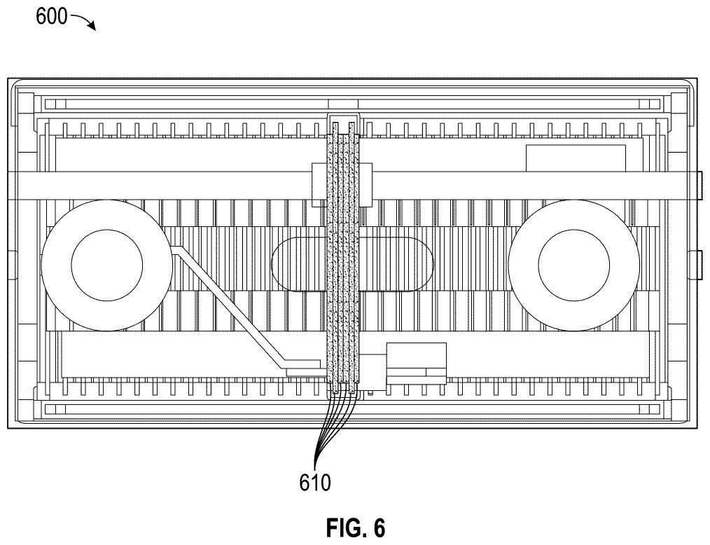

FIG. 6 shows the front view of a modified second type of prismatic battery cell 600 with a greater density of energy units, in accordance with some embodiments of the present disclosure. The modified second type of prismatic battery cell 600 may be modified with respect to the prismatic battery cell 900 of FIG. 9. Compared to the prismatic battery cell 900, the modified prismatic battery cell 600 does not include center post 500 and instead includes additional energy units 610. These additional energy units 610 may occupy the center (e.g., the region occupied by center post 500) of the prismatic battery cell of FIG. 5.

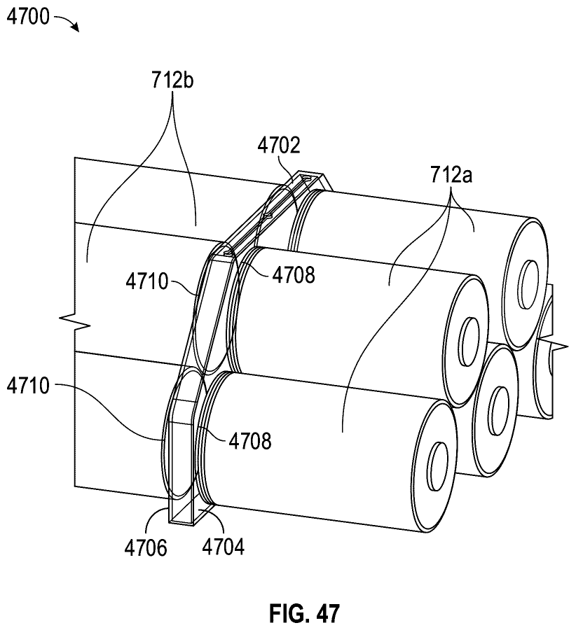

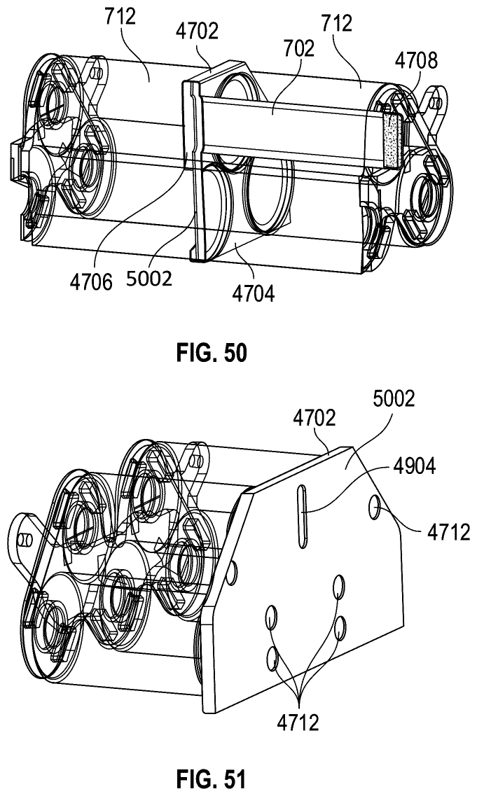

FIG. 7 shows a second modified center post 700 (e.g., which may correspond to exhaust plate 4702 of FIG. 47) and a corresponding fastening arrangement, in accordance with some embodiments of the present disclosure. The center post 700 includes a center vent structure (e.g., thermal vent 702) configured to receive gas released from one or more energy units and release the gas outside of the housing 710. In some embodiments, one or more energy units 712 may be mounted (e.g., at a first interface 4708 or a second interface 4710 as shown in FIG. 47) to center post 700 at the energy unit mounts 704 (e.g., which may correspond to primary exhaust receivers 4720), such that an outgas released from the one or more energy units may flow (e.g., along exhaust path 4901 as shown in FIG. 47) through exhaust plate 706 (e.g., through passageway 4902) and release from housing 710 via thermal vent 702. Center post 700 also includes the exhaust plate 706 (e.g., which may include first side 4704 and second side 4706 as shown in FIG. 47, as well as middle layer 5002 as shown in FIG. 50), which provides the aforementioned outgas exhaust path as well as fastener holes 708. Housing 710 includes fastener holes 714. Center post 700 may be affixed to housing 710 via fasteners 715, which may pass through fastener holes 708 and fastener holes 714.

In some embodiments, center post 700 (including thermal vent 702, exhaust plate 706, or both) has a yield strength of at least 20, 40, 60, 80 100, 120, 140, 160, 180, or 200 MPa. In some embodiments, center post 700 includes a first end plate (e.g., the side that includes fastener holes 708) and a second end plate (e.g., the side opposite the first end plate). Each of the first end plate and the second end plate of center post 700 may be arranged with a clearance 716 between each edge of each end plate and each edge of housing 710. The portion of center post 700 between the first end plate and the second end plate may be arranged parallel to the smallest dimension component of housing 710.

It is noted that, in some embodiments, FIG. 7 shows a portion of the third type of prismatic battery cell 4600 of FIGS. 46A and B, with various components removed to better illustrate at least the center post 700. In some embodiments, the plurality of energy units 712 are on both sides of center post 700 and thus surround the center post 700.

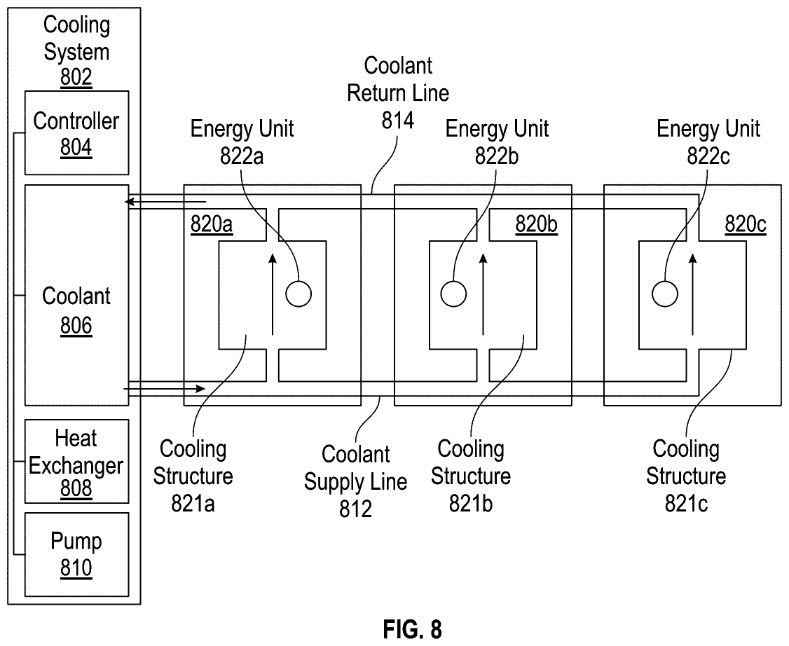

FIG. 8 shows a block diagram of battery cooling system 802, in accordance with some embodiments of the present disclosure. The battery cooling system 802 includes a controller 804, a coolant 806, a heat exchanger 808 (e.g., a compressor, evaporator, condenser, or any other suitable heat exchanger), and a pump 810. The controller is configured to control properties (e.g., a cooling rate and/or a flow rate) of the heat exchanger 808 and/or the pump 810 based on a temperature of coolant 806 and/or a desired cooling power to provide to the connected battery cells 820. Coolant 806 is configured to be provided (e.g., based on a pressure provided by pump 810) to battery cells 820 (e.g., which may include any one or more of prismatic battery cell 100, prismatic battery cell 900, or prismatic battery cell 4600) through coolant supply line 812 (e.g., a first coolant line) and to be returned to cooling system 802 through coolant return line 814 (e.g., a second coolant line). As shown, each of the coolant supply line 812 and the coolant return line 814 pass through each of the battery cells 820. Each cooling structure 821 may include a fluid path (e.g., fluid path 1502 of FIG. 15), and coolant supply line 812 and coolant return line 814 may each be fluidically coupled to the fluid path.

Battery cells 820 include one or more (e.g., any suitable integer “N”) battery cells, with battery cell 1 820a, battery cell 2 820b, and battery cell N 820c shown for illustrative purposes only. Each respective battery cell has a respective cooling structure 821 and at least one energy unit 822, where each of the at least one energy unit 822 is thermally coupled to the corresponding cooling structure 821. The at least one energy unit 822 may include multiple energy units (e.g., as shown at least in connection with prismatic battery cell 100, prismatic battery cell 900 of FIGS. 9A and B, or prismatic battery cell 4600 of FIGS. 46A and B). Therefore, coolant 806 may reduce, increase, or modify the temperature of each of the one or more energy unit 822 (e.g., coolant 806 may perform cooling or heating operations).

FIG. 9A shows a front view of a second type of prismatic battery cell 900 and its internal components, in accordance with some embodiments of the present disclosure. FIG. 9B shows a rear view of the second type of prismatic battery cell 900 and its internal components, in accordance with some embodiments of the present disclosure. Second type of prismatic battery cell 900 may be similar to the first type of prismatic battery cell 100, with the former configured for use with pouch energy units and the latter configured for use with cylindrical energy units.

In some embodiments, the prismatic battery cell 900 includes center post 500, energy units 504, cooling structures 520, coolant ports 1004 and 1006, coolant line 1008, battery cell terminals 114, and thermal vent 216, as described above and below. In some embodiments, prismatic battery cell 900 also includes electrical protection 902 (e.g., for protecting against electrostatic discharge, preventing current shorting to undesired elements, for providing an extra path to ground, or any combination thereof). It is noted that with respect to FIG. 9 and other embodiments of the present disclosure, battery cell terminal 114a may have a positive or negative polarity, and battery cell terminal 114b has the opposite polarity.

In some embodiments, the prismatic battery cell 900 includes battery passport 904. Battery passport 904 may store data related to the historic usage of a battery cell, including but not limited to battery cell purchases and sales, charge/discharge cycles, temperature, duration in the field, geography, system integration, state-of-charge, maximum power and/or energy capacity, any other suitable battery information, or any combination thereof. In some embodiments, the prismatic battery cell 900 includes output connector 906. Output connector 906 may connect a battery cell to a battery management system, a cooling system (e.g., cooling system 802 or 1702), any other suitable system, or any combination thereof.

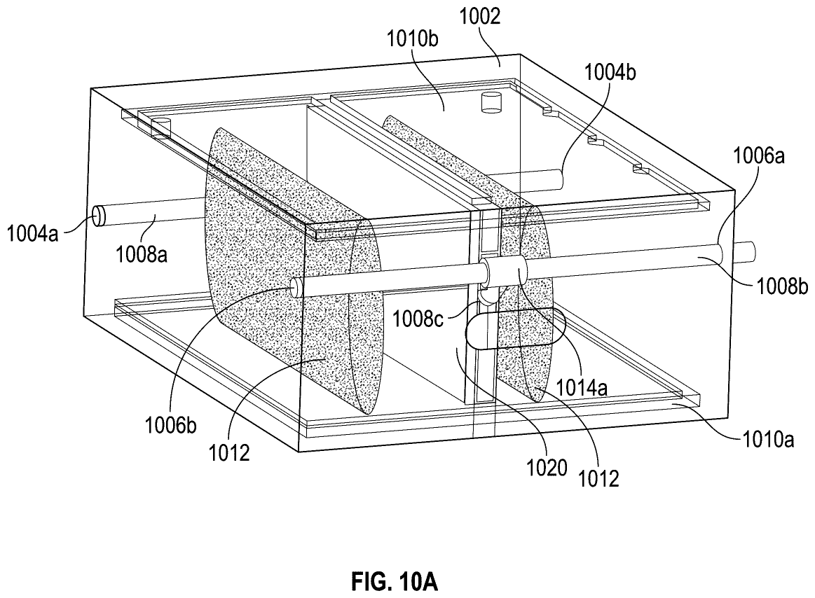

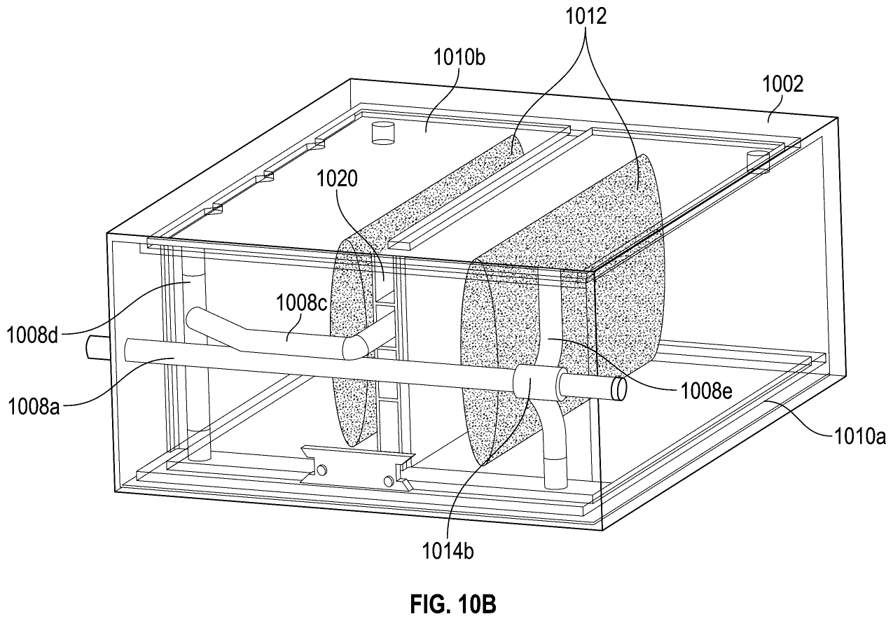

FIG. 10A shows a front view of cooling equipment of the second type of prismatic battery cell, in accordance with some embodiments of the present disclosure. FIG. 10B shows a rear view of cooling equipment of the second type of prismatic battery cell, in accordance with some embodiments of the present disclosure. As shown, the second type of prismatic battery cell includes housing 1002, which includes at least one inlet port (e.g., coolant ports 1004a and 1006a) and at least one outlet port (e.g., coolant ports 1004b and 1006b), at least one coolant line 1008, at least one cooling structure 1010, and at least one energy unit 1012.

In some embodiments, cooling structures 1010a and 1010b may respectively correspond to cooling structures 520a and 520b, and energy units 1012 may correspond to energy units 504.

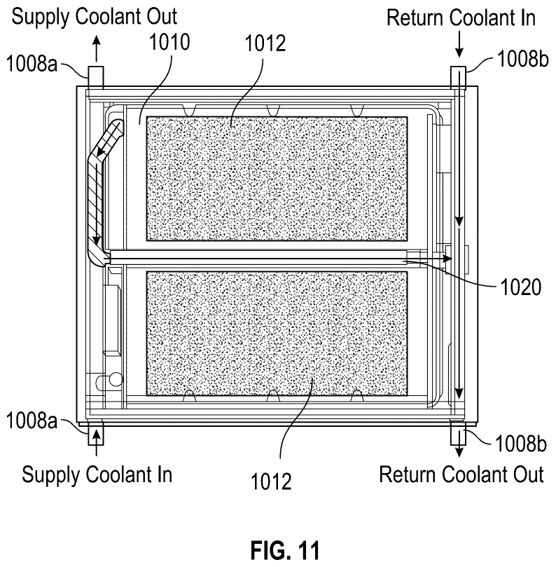

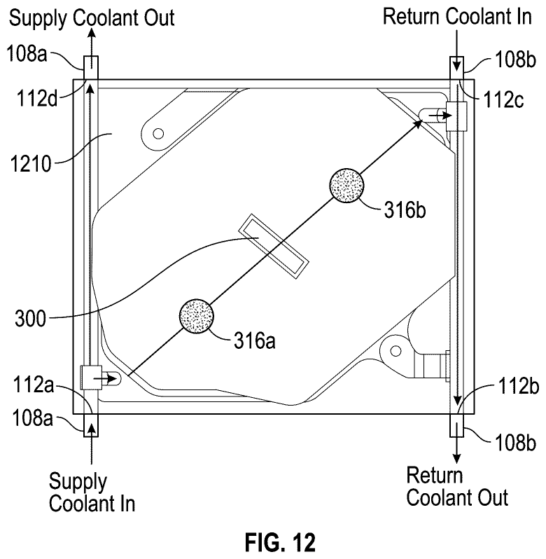

In some embodiments, the at least one inlet port includes a first inlet port (e.g., coolant port 1004a) and a second inlet port (e.g., coolant port 1006a), and the at least one outlet port includes a first outlet port (e.g., coolant port 1004b) and a second outlet port (e.g., coolant port 1006b). Each inlet port receives a coolant (e.g., coolant 806) into housing 1002, and each outlet port returns the coolant (e.g., to a coolant loop of cooling system 802) from housing 1002. As per the flows depicted in FIG. 8 (and as further depicted in at least FIGS. 11 and 12), a first coolant line (e.g., coolant line 1008a) (e.g., for supplying a coolant to one or more cooling structure 1010) may extend between the first inlet port (e.g., coolant port 1004a) and the first outlet port (e.g., coolant port 1004b), and a second coolant line (e.g., coolant line 1008b) (e.g., for returning a coolant from more cooling structure 1010) may extend between the second inlet port (e.g., coolant port 1006a) and the second outlet port (e.g., coolant port 1006b). The supplied coolant may be received from a cooling system (e.g., cooling system 802) at a first temperature, and the returned coolant may be returned to the cooling system at a second temperature, greater (e.g., during operation in a cooling mode) or less than (e.g., during operation in a heating mode) than the first temperature. The coolant 806 temperature may increase when flowing through the cooling loop coupled to cooling system 802 due to absorbing heat generated by the least one energy unit 1012. In particular, the coolant 806 may flow through a fluid path (e.g., fluid path 1502 or a related fluid path) of at least one cooling structure (e.g., cooling structure 1010a and/or cooling structure 1010b), and the fluid may absorb heat because the at least one cooling structure is thermally coupled to each of the at least one energy unit 1012 in the corresponding prismatic battery cell. In other words, both the first coolant line 1008a and the second coolant line 1008b are coupled to at least one cooling structure 1010. In some embodiments, the first coolant line 1008a is arranged parallel to the second coolant line 1008b.

The rear view of FIG. 10B shows additional details of the cooling equipment, including the configuration of coolant lines 1008 and their coupling to cooling structures 1010. As mentioned at least in connection with FIG. 5, center post 1020 includes openings (e.g., openings 501). Coolant line 1008c (which connects to coolant line 1008b via socket 1014a) runs through at least one of the openings in center post 1020 to connect to coolant line 1008d and thereby receive coolant (e.g., coolant 806) from cooling structures 1010a and 1010b after it has flowed through the fluid paths (e.g., similar to fluid path 1502) of these respective cooling structures. It is noted that this coolant enters the cooling structures from coolant line 1008e, which receives the fluid from first coolant line 1008a (e.g., the coolant supply line) via socket 1014b.

FIG. 11 shows coolant flow through the second type of prismatic battery cell, in accordance with some embodiments of the present disclosure. Consistent with the depictions in FIGS. 9 and 10, first coolant line 1008a includes a “supply coolant in” side, which provides a portion of coolant (e.g., coolant 806) to cooling structures 1010; first coolant line 1008a also includes a “supply coolant out” side, which provides the remainder of the coolant to the downstream prismatic battery cells (e.g., with reference to the multiple battery cells shown in FIG. 8). Second coolant line 1008b includes a “return coolant in” side, which receives a portion of coolant (e.g., coolant 806) from upstream prismatic battery cells (e.g., with reference to the multiple battery cells shown in FIG. 8); second coolant line 1008b also includes a “return coolant out” side, which receives the portion of coolant from the upstream prismatic battery cells and a portion of coolant from cooling structures 1010, to provide both portions of the coolant to downstream prismatic battery cells or to a coolant reservoir of a cooling system (e.g., cooling system 802). The direction of the supply coolant flow opposes the direction of the return coolant flow (e.g., as shown in FIG. 8 based on flows through coolant supply line 812, coolant return line 814, and cooling system 802).

FIG. 12 shows coolant flow through the prismatic battery cell 100, in accordance with some embodiments of the present disclosure. It is noted that coolant lines 108 and coolant ports 112 may be similar to coolant lines 1008 (albeit with different coupling to the cooling structure and routing through the prismatic battery cell) and to coolant ports 1004/1006. First coolant line 108a includes a “supply coolant in” side, which provides a portion of coolant (e.g., coolant 806) to cooling structure 1210 (which may correspond to cooling structure 110) via coolant line 108c; first coolant line 108a also includes a “supply coolant out” side, which provides the remainder of the coolant to the downstream prismatic battery cells (e.g., with reference to the multiple battery cells shown in FIG. 8). Second coolant line 108b includes a “return coolant in” side, which receives a portion of coolant (e.g., coolant 806) from upstream prismatic battery cells (e.g., with reference to the multiple battery cells shown in FIG. 8); second coolant line 108b also includes a “return coolant out” side, which receives the portion of coolant from the upstream prismatic battery cells and a portion of coolant from cooling structure 1210 via coolant line 108b, to provide both portions of the coolant to downstream prismatic battery cells or to a coolant reservoir of a cooling system (e.g., cooling system 802). The direction of the supply coolant flow opposes the direction of the return coolant flow (e.g., as shown in FIG. 8 based on flows through coolant supply line 812, coolant return line 814, and cooling system 802).

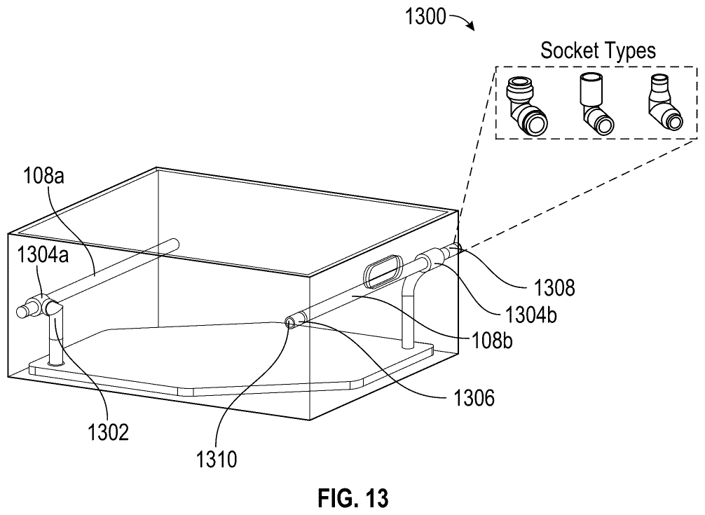

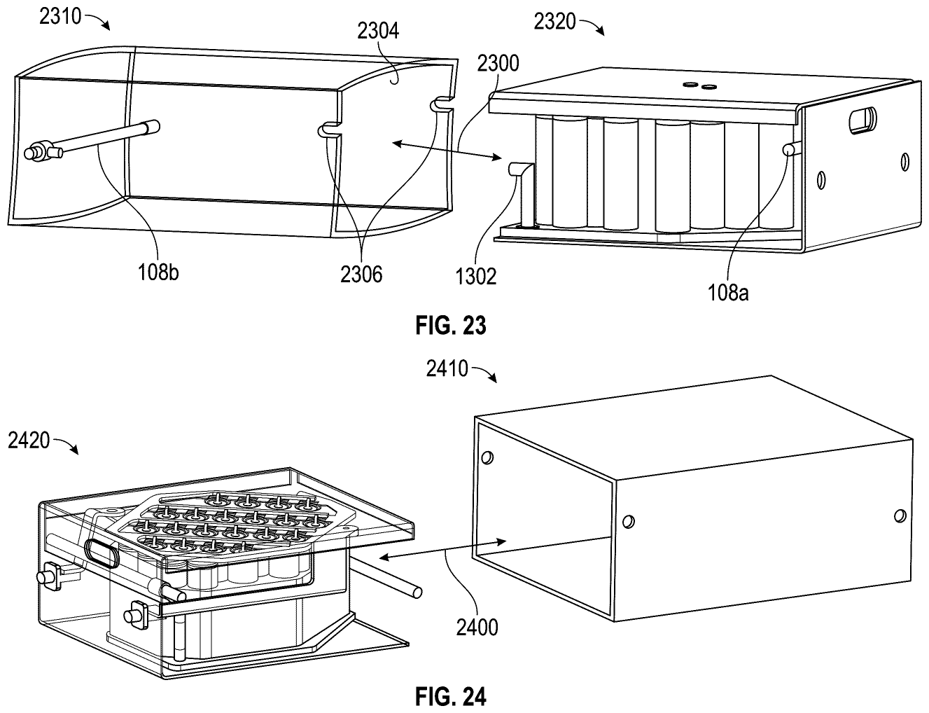

FIG. 13 shows cooling sockets 1300, in accordance with some embodiments of the present disclosure. While cooling sockets 1300 are shown in FIG. 13 in connection with the first prismatic battery cell, they may also be similarly used in connection with the second or third types of prismatic battery cells. Illustrative cooling sockets 1300 include any one or more of the socket types shown in the inset. Any suitable socket of the cooling sockets 1300 may be arranged to provide the coolant line connections made by sockets 1302, 1304, 1306, and 1308. In some embodiments, an opening (e.g., socket cutout 1310, which may, in some embodiments, correspond to cutout 2306) is cut out of a side of a battery cell housing through which a coolant line extends. In some embodiments, as further described at least in connection with FIG. 23, the socket cutout 1310 extends to an edge of the battery cell housing and permits a removable panel (e.g., the panel including the battery cell terminals) to be readily installed to or released from the battery cell housing while having a coolant line mechanically coupled to the removable panel.

As shown in FIG. 13, respective ends of coolant lines 108a and 108b include respective sockets (e.g., sockets 1304, 1306, and 1308), each of which is configured to couple to at least one inlet port or at least one outlet port. In some embodiments, at least one of the sockets is configured to mate with a cooling line of an additional battery cell (e.g., with reference to the multi-cell configuration shown in FIG. 8). In some embodiments, the housing of the prismatic battery cell 100, the housing of the prismatic battery cell 900, and the housing of the prismatic battery cell 4600 are each diagonally symmetric, such that upon rotating any of the respective battery cells by 180 degrees, the at least one of the cooling sockets 1300 remains configured to mate with the cooling line of the additional battery cell.

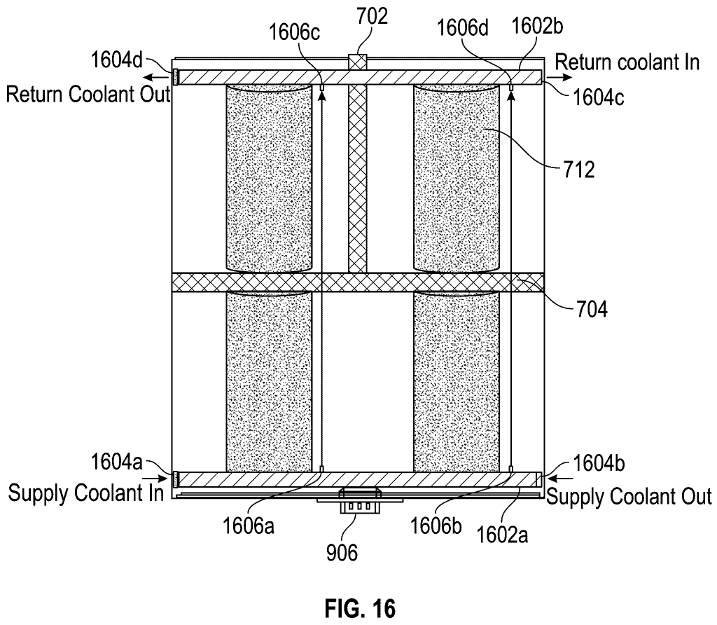

After cooling multiple energy units for a certain amount of time, particular ones of the energy units will be characteristically cooler and other particular ones of the energy units will be characteristically warmer. The respective locations of the cooler and warmer energy units will depend on the coolant flow path. For example, with coolant flowing from the left-to-right side of the second type of prismatic battery cell (e.g., as shown in FIG. 11), the bottom-most energy units will be cooler and the top-most energy units will be warmer; thus, rotating the battery cell by 180 degrees will permit the warmer energy units to thereafter receive more cooling. For another example, with coolant flowing from the bottom-left to top-right corners of the first prismatic battery cell (e.g., as shown in FIG. 12), the bottom-left-most energy units will be cooler and the top-right-most energy units will be warmer; thus, rotating the battery cell by 180 degrees will permit the warmer energy units to thereafter receive more cooling. For another example, with coolant flowing from the bottom-to-top of the third type of prismatic battery cell (e.g., as shown in FIG. 16), the bottom-most energy units will be cooler and the top-most energy units will be warmer; thus, rotating the battery cell by 180 degrees will permit the warmer energy units to thereafter receive more cooling. In other embodiments, the aforementioned teachings for cooling multiple energy units may be applied to heating multiple energy units. In such heating operations, the energy units arranged closest to the coolant supply inlet would be the warmest energy units, and those arranged closest to the coolant return outlet would be the coolest energy units. Thus, rotating the battery cell by 180 degrees will permit the cooler energy units to thereafter receive more heating.

It is noted that upon rotating a prismatic battery cell by 180 degrees, a respective coolant supply line will become a coolant return line, and vice versa. Respective inlet ports and outlet ports will remain as inlet and outlet ports, but the rotation will cause these ports to switch from being coupled to the supply line to being coupled to the return line (or vice versa).

It is noted that while prismatic battery cell 100, prismatic battery cell 900, and prismatic battery cell 4600 each are shown with respective cooling systems, and while FIG. 13 generally depicts the cooling system associated with prismatic battery cell 100, the illustrative cooling sockets 1300 (including various possible socket types, as shown) and the illustrative sockets 1302, 1304, 1306, and 1308 may be used with any of the three types of prismatic battery cells (e.g., for making internal coolant line connections and/or for coupling to a coolant line that extends outside of a housing of the battery cell).

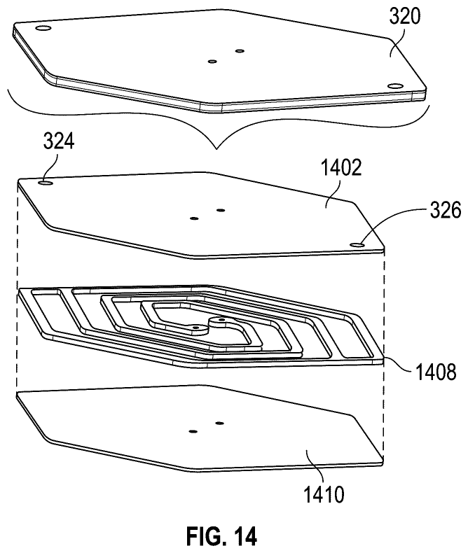

FIG. 14 shows an exploded view of cooling structure 320, in accordance with some embodiments of the present disclosure. FIG. 15 shows a coolant fluid flow path 1502, in accordance with some embodiments of the present disclosure. Cooling structure 320 is a layered stack including cooling structure first side 1402, baffle structure 1408, and cooling structure second side 1410. In some embodiments, the geometry of baffle structure 1408 is integrated (e.g., via machining or etching) directly into cooling structure second side 1410, such that the two components are provided as a single component. Cooling structure first side 1402 includes coolant port 324 and coolant port 326, which mechanically couple the coolant (e.g., coolant 806) to the fluid path 1502 and thus thermally couples the coolant to each of the multiple energy units that are thermally coupled to the cooling structure. Baffle structure 1408 defines a path of coolant flow and may be any suitable geometry to provide a desired cooling rate for respective prismatic battery cells coupled to the cooling system 802. Cooling structure second side 1410 encloses the fluid path 1502 and directly affixes the cooling structure 320 to a housing of the prismatic battery cell.

It is noted that cooling structure 520, though not shown in an exploded view, has a similar layered stack to that of cooling structure 320 but with the respective coolant ports of cooling structure 520 are located in different positions (e.g., corresponding to the fluid connections shown in FIGS. 9B and 10B, as shown in FIG. 5). Similarly, the geometry of the baffle structure within cooling structure 520 would differ at least to provide inlet and outlet locations corresponding to the respective coolant ports.

In some embodiments, either of cooling structure 320 or cooling structure 520 may correspond to any one of the cooling structures 821, cooling structure 1721, or both.

FIG. 16 shows coolant flow through the third type of prismatic battery cell 4600, in accordance with some embodiments of the present disclosure. Prismatic battery cell 4600 includes a first coolant line 1602a and a second coolant line 1602b. First coolant line 1602a is coupled to inlet port 1604a and outlet port 1604b; second coolant line 1602b is coupled to inlet port 1604c and outlet port 1604d. With respect to the supply and return configurations and the diagonal symmetry, coolant lines 1602 operate similarly to coolant lines 1008 and 1208. However, distinct from those coolant lines, coolant lines 1602 include a series of coolant line taps. Coolant line taps 1606a and 1606b release coolant (e.g., coolant 806) from coolant line 1602a into the prismatic battery cell 4600, and coolant line taps 1606c and 1606d retrieve coolant from the prismatic battery cell to return the coolant to another prismatic battery cell or to a cooling system (e.g., as shown and described in connection with FIG. 8).

In some embodiments, the coolant (e.g., as is used to cool the prismatic battery cell 4600, based at least in part on the configuration shown in FIG. 16) is a liquid coolant and at least a portion of each energy unit 712 is submerged in the coolant. Thus, the prismatic battery cell 4600 may cool the energy units 712 without the need for a cooling structure. Coolant line taps 1606 may be of a suitable size to supply and return coolant, without permitting significant mixing of the coolant of coolant line 1602a with the coolant of coolant line 1602b.

In some embodiments, the housing of prismatic battery cell 4600 may not include coolant lines 1602. Accordingly, the lines supplying and returning the coolant may only extend to one or more edges of the housing. For example, such coolant lines may be provided to couple a coolant (e.g., coolant 806) to other battery cells (e.g., battery cells 820) and/or a corresponding cooling system (e.g., cooling system 802). In such an implementation, the coolant flows shown in FIG. 16 may be achieved by one or more pressure differentials applied by the cooling system.

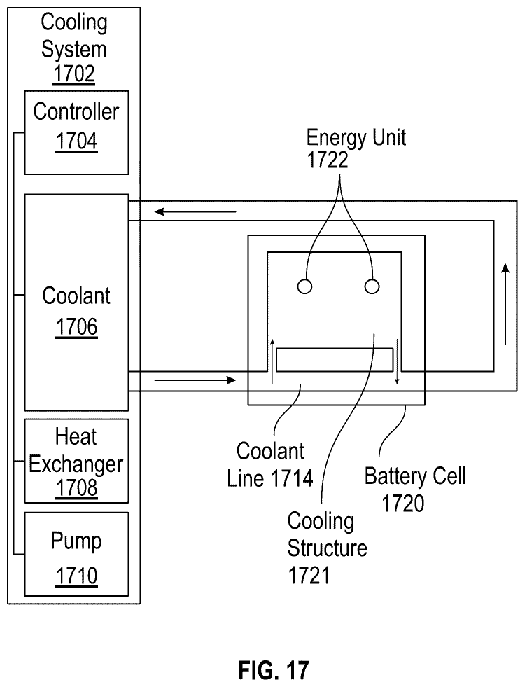

FIG. 17 shows a cooling system 1702 coupled to a prismatic battery cell (e.g., any of the first type of prismatic battery cell 100, the second type of prismatic battery cell 900, or the third type of prismatic battery cell 4600) with a single coolant line, in accordance with some embodiments of the present disclosure. In some embodiments, controller 1704, coolant 1706, heat exchanger 1708, pump 1710, battery cell 1720, cooling structure 1721, and energy unit 1722 may respectively correspond to controller 804, coolant 806, heat exchanger 808, pump 810, battery cell 820, cooling structure 821, and energy unit 822. Coolant line 1714 fluidically couples battery cell 1720 to cooling system 1702. As shown, coolant line 1714 may be the only coolant line of battery cell 1720, with the cooling structure 1721 configured to receive coolant 1706 from the coolant line and provide coolant to the coolant line. Cooling structure 1721 may include baffling or any other suitable fluid path for directing coolant 1706 into the left side (as shown) of the cooling structure and out of the right side of the cooling structure. Battery cell 1720 has only two coolant ports, corresponding to the inlet and outlet of coolant line 1714. Outside of battery cell 1720, coolant 1706 follows a loop back to return to a reservoir of cooling system 1702.

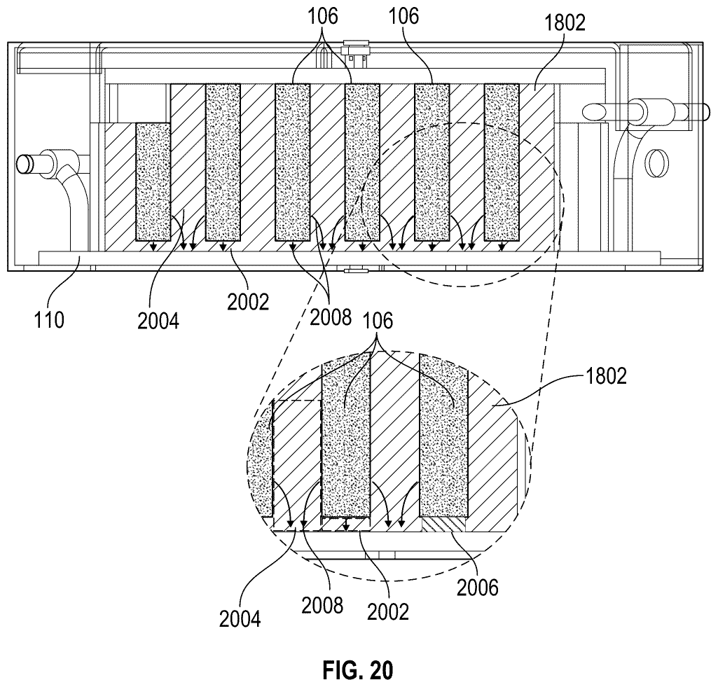

FIG. 18 shows thermally conductive potting material 1802 of the first prismatic battery cell, in accordance with some embodiments of the present disclosure. In some embodiments, the prismatic battery cell 100 includes cooling structure 110, multiple energy units 106 thermally coupled to the cooling structure via first interface 2002 (as further described at least in connection with FIG. 20), and thermally conductive potting material 1802, which thermally couples the multiple energy units 106 to each other and to the cooling structure via second interface 2004 (as further described at least in connection with FIG. 20). In some embodiments, a thermal conductivity of the thermally conductive potting material 1802 is at least 2 W/m*K.

In some embodiments, thermally conductive potting material 1802 also provides mechanical support and/or geometric alignment to the multiple energy units 106. For example, the multiple energy units 106 may be cylindrical energy units arranged parallel to each other, and thermally conductive potting material 1802 may mechanically and/or geometrically support this arrangement. Accordingly, an adhesive strength of thermally conductive potting material 1802 may be at least 10 MPa.

In some embodiments, thermally conductive potting material 1802 is also electrically conductive. For example, an electrical conductivity of the thermally conductive potting material 1802 may be at least 1e-6 S/m, 1e-5 S/m, 1e-4 S/m, 1e-3 S/m, 1e-2 S/m, 0.1 S/m, 1 S/m, or 10 S/m. In some embodiments, the multiple energy units 106 are electrically coupled in parallel, and thermally and electrically conductive potting material 1802 provides at least a portion of the parallel electrical connection between these energy units.

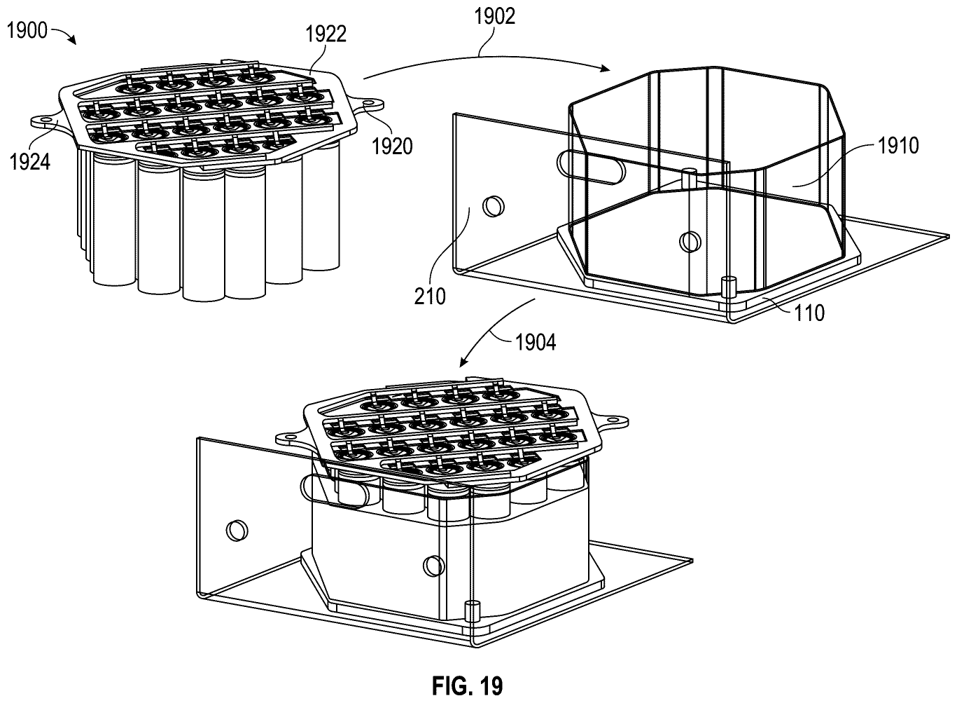

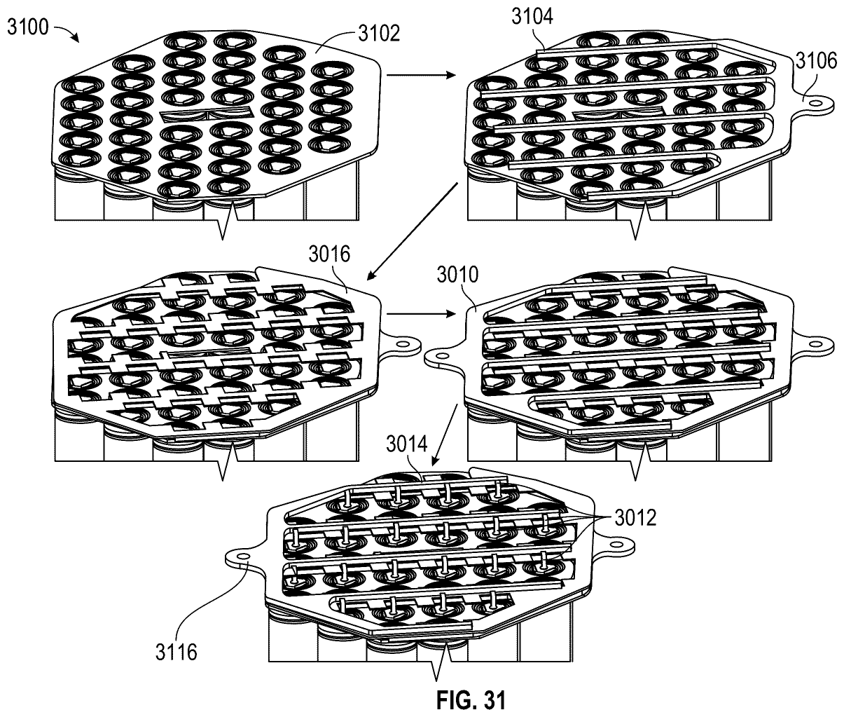

FIG. 19 shows a sequence 1900 for assembling a portion of the first prismatic battery cell, in accordance with some embodiments of the present disclosure. As shown and as further described at least in connection with FIGS. 30-31, the assembly sequence 1900 operates on a first construction including multiple cylindrical energy units 106 arranged in parallel beneath first electrical conductor 1920 (e.g., which may correspond to first electrical conductor 3004), insulating layer 1922 (e.g., which may correspond to insulating layer 3016), and second electrical conductor 1924 (e.g., which may correspond to second electrical conductor 3010).

At step 1902, the first construction is inserted into a second construction including potting housing 1910, cooling structure 110, and removable front panel 210. As shown, potting housing 1910 is connected to cooling structure 110, which is connected to removable front panel 210. As further described at least in connection with FIGS. 21, 23, 24, and 28, removable front panel 210 may be readily installed or removed from an enclosure (e.g., housing 202 or housing 1002), such that a battery cell including thermally conductive potting material 1802 (e.g., the first prismatic battery cell) also includes a housing having a removable side (e.g., removable front panel 210).

At step 1904, thermally conductive potting material 1802 is poured or otherwise applied to the inside of potting housing 1910. Based on this application and the aforementioned connections, cooling structure 110, multiple energy units 106, and thermally conductive potting material 1802 are coupled to removable front panel 210. Likewise, thermally conductive potting material 1802 thermally couples multiple energy units 106 to cooling structure 110 (e.g., via first interface 2002). Moreover, as a result of this arrangement, removing removable front panel 210 from a prismatic battery cell housing (e.g., housing 202 or housing 1002) removes all these coupled components from the prismatic battery cell housing. In some embodiments, the removable side includes two electrical terminals for coupling to the multiple energy units 106.

FIG. 20 shows thermal interfaces of thermally conductive potting material 1802, in accordance with some embodiments of the present disclosure. As used herein, an interface may refer to a volume or a composite one or more materials arranged between two surfaces that are thermally (and, in some embodiments, electrically and/or mechanically) coupled to each other. In some embodiments, FIG. 20 shows a side view of prismatic battery cell 100 (e.g., as depicted in FIG. 1, although certain aspects may be omitted in FIG. 20 for clarity). First interface 2002 includes the material (e.g., thermally conductive potting material 1802, and optionally adhesive 2006) between respective bottom faces (e.g., ends) of the multiple energy units 106 and corresponding portions of the top side of cooling structure 110. For further clarity, the dashed-line region shown in the inset of FIG. 20 depicts how first interface 2002 includes the volume between a respective bottom face and a corresponding portion of the top side of a cooling structure.

In some embodiments (e.g., when greater adhesive strength between the multiple energy units 106 and the top side of cooling structure 110 is desired), the prismatic battery cell of FIG. 20 also includes adhesive 2006, different than thermally conductive potting material 1802, that adheres at least a portion of each respective bottom face of the multiple energy units 106 to a portion of the top side of cooling structure 110. While adhesive 2006 is only illustrated in FIG. 20 as being arranged in connection with one energy unit 106, it is noted that respective volumes of adhesive 2006 may similarly be arranged in connection with each of the multiple energy units 106. In some embodiments, adhesive 2006 also thermally couples each of the adhered multiple energy units 106 to cooling structure 110 via first interface 2002.

When each respective volume of adhesive 2006 is applied between a portion of a bottom face of one of the multiple energy units 106 and a corresponding portion of the top side of cooling structure 110, each first interface 2002 may include the respective volume of adhesive 2006 and the respective portion of thermally conductive potting material 1802 that surrounds adhesive 2006 and is adhered to the remainder of the corresponding bottom face.

Second interface 2004 includes the material (e.g., thermally conductive potting material 1802) between respective cylindrical sides of the multiple energy units 106 and the top side of cooling structure 110. For further clarity, the dashed-line region shown in the inset of FIG. 20 depicts how second interface 2004 includes the volume between respective cylindrical sides of the multiple energy units 106. Second interface 2004 may extend vertically to any suitable height along the axis of each respective cylindrical side. With respect to a bottom limit of second interface 2004, it may extend all the way down to the top of the cooling structure, it may extend to the bottom of each respective cylindrical side, or it may extend any other suitable distance. With respect to a top limit of second interface 2004, it may extend vertically to cover a threshold portion of the cylindrical sides of the multiple energy units 106. In some embodiments, the second interface 2004 extends vertically to cover at least 5%, at least 10%, at least 15%, at least 20%, at least 25%, at least 35%, at least 50%, at least 75%, or up to 100% of the height of each of the multiple energy units 106.

It is noted that thermally conductive potting material 1802 may improve the ability of cooling structure 110 and a related cooling system (e.g., cooling system 802 or 1702) to regulate temperatures of the multiple energy units 106. As depicted by the heat flux vectors 2008, heat generated by respective ones of the multiple energy units 106 may flow into cooling structure 110 through first interface 2002, second interface 2004, or both. In some embodiments, the first interface 2002, the second interface 2004, or both are provided for heating the multiple energy units 106, in which case heat flux vectors 2008 would be oriented in opposite directions compared to those as shown in FIG. 20.

FIG. 21A shows a first coupling 2100 between a housing 2110 with an opening 2104 and a removable side 2120 configured to cover the opening, in accordance with some embodiments of the present disclosure. In some embodiments, in the installed position, the two-way arrow of coupling 2100 and the interface 2150 may correspond to first type of prismatic battery cell 100 and/or second type of prismatic battery cell 900. A prismatic battery cell as shown in FIG. 21 also includes at least one energy unit 106 (which may, in other embodiments, correspond to at least one energy unit 1012) that is coupled to removable side 2120. As indicated by the two-way arrow of coupling 2100, in the installed position, removable side 2120 is inserted into housing 2110 and covers opening 2104 such that removable front panel 2122 forms a front panel of the housing. In the removable position, removable side 2120 may be removed from housing 2110, which causes the at least one energy unit 106 to be removed from the housing.

In some embodiments, the removable side 2120 is coupled to a frame member (e.g., at least one of top frame member 2124 or bottom frame member 2126) that is configured to, in the installed position, be arranged adjacent to an inner surface of the housing. For example, in the installed position, top frame member 2124 may be adjacent to the top surface (e.g., the inner surface of bowed out side 2102a) of housing 2110 and bottom frame member 2126 may be adjacent to the bottom surface (e.g., the inner surface of bowed out side 2102b) of the housing.

In some embodiments, the removable side 2120 includes at least one thermal vent (e.g., thermal vent 216) (e.g., to provide a path for an outgas expelled from an energy unit 106 to exit the housing 2110).

In some embodiments, the removable side 2120 includes battery cell terminals 114, each of which is coupled to a respective side of one or more of the energy units 106.

FIG. 21B shows an interface 2150 between the housing 2110 and the removable side 2120, in accordance with some embodiments of the present disclosure. As shown, in the installed position, the removable side (specifically removable front panel 2122 of the removable side) covers opening 2104 to form a sealed enclosure around the at least one energy unit 106. In some embodiments, the removable side also includes a gasket 2152, and the gasket forms a seal between the removable side 2120 and the opening 2104. In particular, in the installed position, the gasket 2152 may be arranged between each recess 2154 in each flat side 2106 to thermally seal the enclosure (in particular, to thermally seal the region between flat sides 2106 and removable front panel 2122).

FIG. 22 shows a battery cell with bowed out sides, before and after fastening, in accordance with some embodiments of the present disclosure. In some embodiments, the battery cell of FIG. 22 may correspond to the first type of prismatic battery cell 100 or the second type of prismatic battery cell 900. In the before fastening state 2200, a removable side (e.g., removable side 2120) is inserted and optionally installed into housing 2110, and bowed out sides 2102 remain bowed out (e.g., to provide clearance for inserting the removable side). As shown, fasteners 2202 (which may correspond to fasteners 313, fasteners 508, and/or fasteners 715) are arranged over fastener holes (e.g., fastener holes 314, fastener holes 506, and/or fastener holes 708) cut out of the bowed out sides 2102, but are not yet fastened to any internal component of the battery cell. During the fasten step 2204, the fasteners 2202 are mechanically coupled to the corresponding fastener holes. In some embodiments, the removable side 2120 includes a center post (e.g., center post 104, 300, 500, or 1020) and the fasten step 2204 includes coupling the center post to opposite sides (which may be bowed out, as shown in FIG. 21, or may be flat) of the housing. In the after fastening state 2250, bowed out sides 2102 are flattened due to fasteners 2202 coupling the housing 2110 to the removable side 2120. In other words, coupling the opposite sides of the housing 2110 to the removable side 2120 (e.g., to at least one frame member coupled to the removable side) causes the opposite sides of the housing 2110 to flatten out.

FIG. 23 shows a second coupling 2300 between a housing 2310 with an opening 2304 and a removable side 2320 configured to cover the opening, in accordance with some embodiments of the present disclosure. Housing 2310 and removable side 2320 of FIG. 23 may respectively correspond to housing 2110 and removable side 2120, except the depictions of FIG. 23 move coolant line 108b from the removable side to the housing. As a result, removing the removable side 2320 involves decoupling coolant line socket 1302 from coolant line 108b, rather than decoupling coolant line 108b from coolant ports 112a and 112d (as would occur when removing removable side 2120 from housing 2110.

Thus, the removable sides 2120 and 2320 may be coupled to one or two coolant lines (e.g., one or both of coolant lines 108a or 108b). In some embodiments, the housing 2310 includes two openings (e.g., cutouts 2306), where in the installed position, the two openings are aligned with respective ends (e.g., respective ends of coolant line 108a) of the corresponding removable side coolant line. As shown in FIG. 23, when removable side 2320 is only coupled to one coolant line (e.g., coolant line 108a), then housing 2310 may be coupled to a second coolant line (e.g., coolant line 108b).

FIG. 24 shows a third coupling 2400 between a housing 2410 with an opening and a removable side (e.g., removable front panel 2420), in accordance with some embodiments of the present disclosure. In some embodiments, removable front panel 2420 corresponds to removable side 2120. In some embodiments, housing 2410 is similar to housing 2110, except for having additional flat sides in place of the bowed out sides 2102. As shown in FIG. 24, the removable front panel 2420 can slide in and out of the opening of housing 2410, even though the latter element has no bowed out sides.

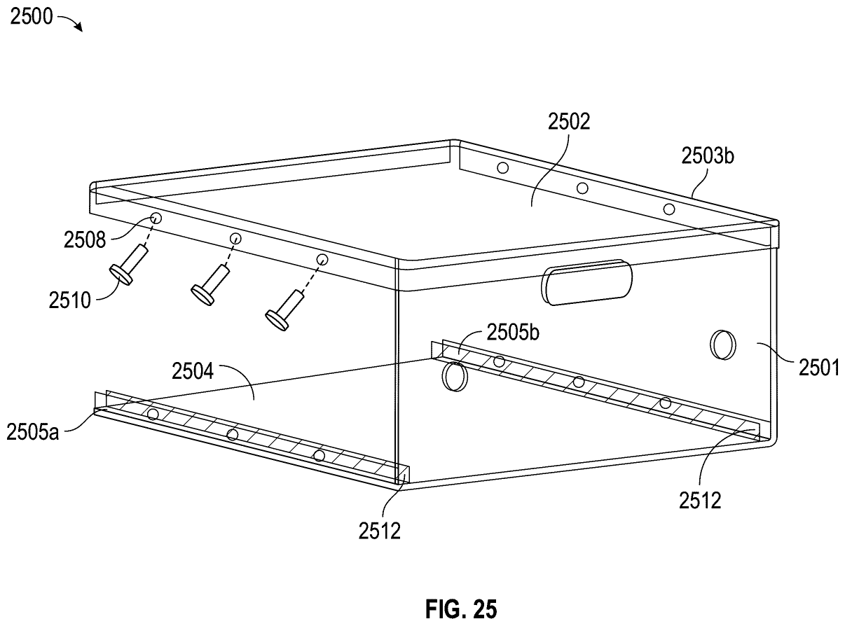

FIG. 25 shows a first approach 2500 for fastening and/or insulating removable side 2501, in accordance with some embodiments of the present disclosure. As shown in FIG. 25, removable side 2501 (which may, in some embodiments, correspond to removable front panel 210 or related embodiments thereof) includes top frame member 2502, which includes lateral sides 2503a and 2503b, and bottom frame member 2504, which includes lateral sides 2505a and 2505b. In some embodiments, the lateral sides 2503 and/or 2505 include bent edges.

Fasteners 2510 are configured to be installed through openings 2508 in the lateral sides 2503 and 2505. In some embodiments, a housing (e.g., housing 2110, 2310, 2410, or related embodiments thereof) in which removable side 2501 is inserted has external lateral side openings corresponding to any one or more of the openings 2508, and the fasteners 2510 are configured to couple the housing to the lateral sides of the frame member through the external lateral side openings.

In some embodiments, thermal insulation 2512 is provided along one or more lateral side 2503 or 2505. In the installed position, the thermal insulation 2512 may provide a thermal and/or substantially air-tight seal between the removable side 2501 and a battery cell housing to which the removable side is coupled. Adding the thermal insulation 2512 may improve an ability of a cooling system (e.g., cooling system 802 or cooling system 1702) to regulate a temperature of one or more energy units and/or of the entire prismatic battery cell. Adding the thermal insulation 2512 may further improve an ability of a battery cell housing (e.g., housing 2110, 2310, 2410, or related embodiments thereof) to isolate nearby equipment from thermal events occurring inside the housing.

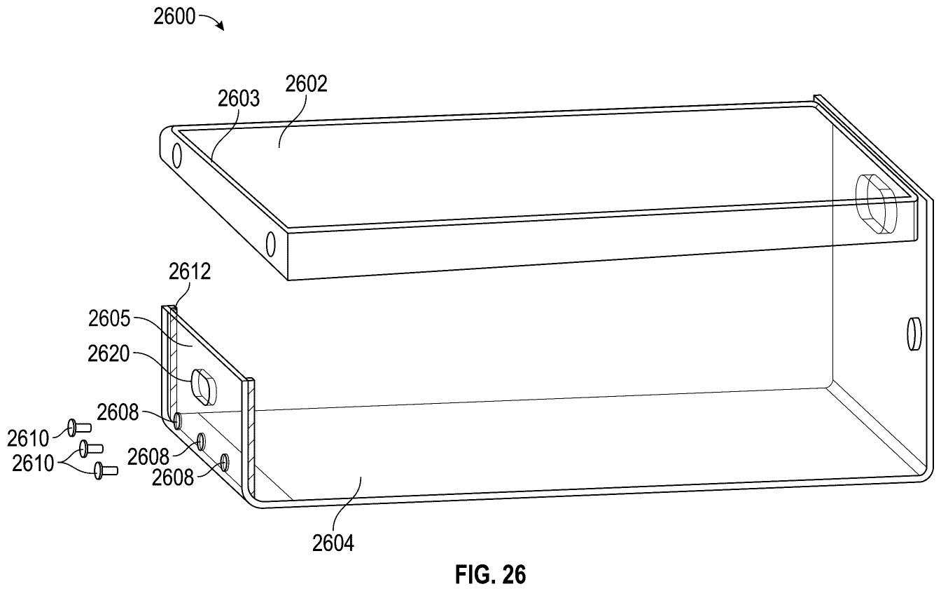

In FIGS. 25-26, it is noted that not all openings (e.g., openings 2508 or 2608) are labeled with a reference numeral for clarity of illustration. Similarly, it is noted that not all openings are shown with corresponding fasteners (e.g., fasteners 2510 or 2610), but this is also for clarity of illustration; indeed, every opening may be configured to have a fastener installed through the opening.

FIG. 26 shows a second approach 2600 for fastening and/or insulating removable side 2601, in accordance with some embodiments of the present disclosure. As shown in FIG. 26, removable side 2601 (which may, in some embodiments, correspond to removable front panel 210 or related embodiments thereof) includes top frame member 2602, which includes lateral side 2603, and bottom frame member 2604, which includes lateral side 2605. In some embodiments, the lateral sides 2603 and/or 2605 include bent edges.

Fasteners 2610 are configured to be installed through openings 2608 in the lateral sides 2603 and 2605. In some embodiments, a housing (e.g., housing 2110, 2310, 2410, or related embodiments thereof) in which removable side 2601 is inserted has external lateral side openings corresponding to any one or more of the openings 2608, and the fasteners 2610 are configured to couple the housing to the lateral sides of the frame member through the external lateral side openings.

In some embodiments, thermal insulation 2612 is provided along one or more edge of lateral side 2605 (e.g., one or more edge of the bent edge of lateral side 2605, as shown). In the installed position, the thermal insulation 2612 may provide the features described in connection with thermal insulation 2512.

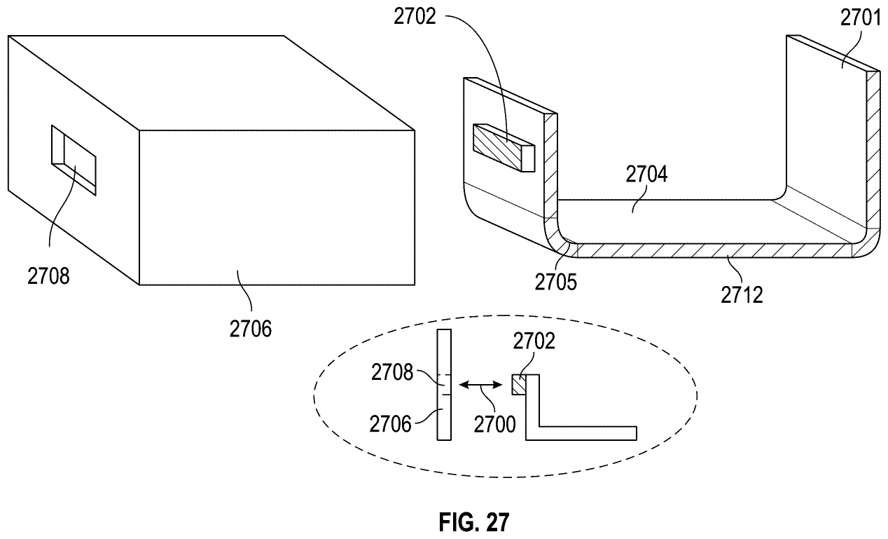

FIG. 27 shows a coupling 2700 between an electrical connector 2702 of a removable side 2701 and a housing 2706, in accordance with some embodiments of the present disclosure. As shown, removable side 2701 (and, thus, a battery cell including the removable side 2701, e.g., prismatic battery cell 100, prismatic battery cell 900, prismatic battery cell 4600, or related embodiments thereof) includes electrical connector 2702. In some embodiments, removable side 2701 includes frame member 2704, which includes lateral side 2705, which includes a bent edge, and electrical connector 2702 is coupled to the bent edge. Housing 2706 includes a rear opening 2708, and the electrical connector is configured to mate with the rear opening (e.g., through coupling 2700) when the removable side is in the installed position. In some embodiments, removable side 2701 also includes a top frame member (e.g., that may correspond to top frame member 2502 or 2602). In some embodiments, electrical connector 2702 may be coupled to housing 2706 (e.g., in place of opening 2708), and removable side 2701 may have an opening (e.g., similar to opening 2708) corresponding to the location of electrical connector 2702 on housing 2706.

In some embodiments, thermal insulation 2712 is provided along one or more edge of housing 2706 (e.g., one or more edge of the bent edge of lateral side 2605, as shown). In the installed position, the thermal insulation 2612 may provide the features described in connection with thermal insulation 2512.

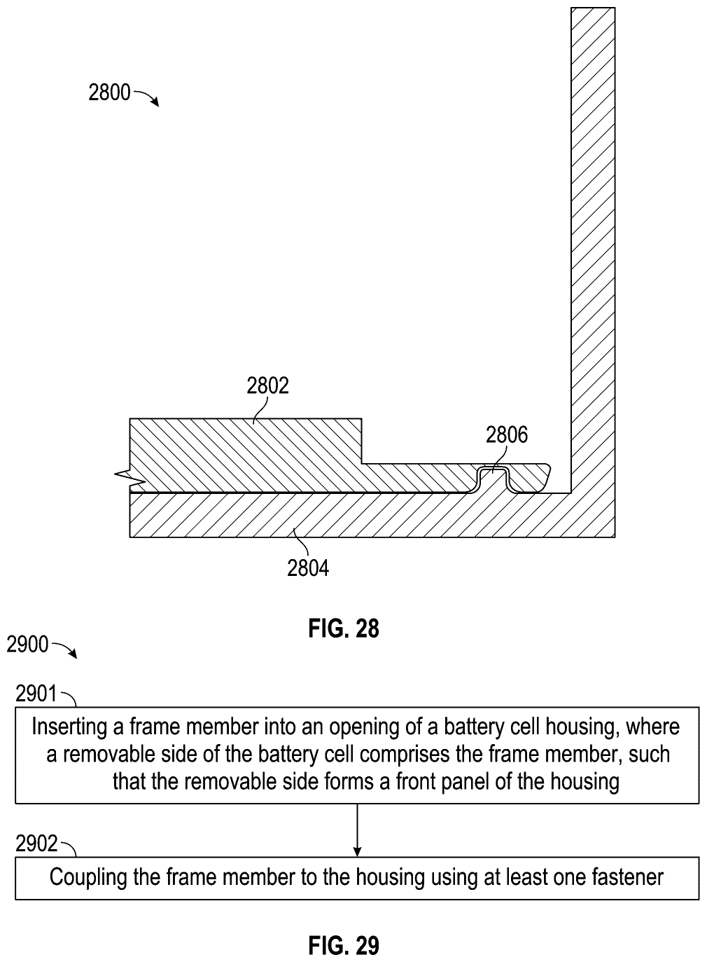

FIG. 28 shows a coupled interface 2800 including snap-fit fastener 2802, in accordance with some embodiments of the present disclosure. In some embodiments, a removable side (e.g., the removable side described at least in connection with any of FIGS. 21-27) is coupled to one or more snap-fit fasteners 2802, and the one or more snap-fit fasteners are configured to couple a frame member of the removable side to a housing of a prismatic battery cell when the removable side is in the installed position. Moreover, the one or more snap-fit fasteners 2802 are configured to decouple the frame member from the housing to enable the removable side to be removed from the housing. In some embodiments, housing 2804 includes one or more protrusions 2806 that are configured to receive and couple to the respective one or more snap-fit fasteners 2802.

It is noted that the fastening, connections, and/or interfaces described at least in connection with FIGS. 25-28 may be used individually or in any suitable combination to secure a housing of a prismatic battery cell to a removable side of the prismatic battery cell (e.g., any of the prismatic battery cell 100, the prismatic battery cell 900, the prismatic battery cell 4600, or related embodiments thereof). Any of the fasteners described in connection with FIGS. 25-28 may be configured to be installed through an external surface of the housing to couple the housing to a frame member of a removable side of the battery cell.

FIG. 29 shows a method 2900 for assembling a battery cell (e.g., any of the first type of prismatic battery cell 100, the second type of prismatic battery cell 900, the third type of prismatic battery cell 4600, or related embodiments thereof) with a removable side (e.g., any of the removable sides described at least in connection with any of FIGS. 21-28), in accordance with some embodiments of the present disclosure. In some embodiments, the removable side includes a frame member (e.g., any one or more of the frame members described at least in connection with FIGS. 25-27) coupled to at least one energy unit (e.g., energy unit 316, 504, 712, or any other suitable energy unit, including those described in connection with the first, second, or third type of prismatic battery cells). Method 2900 includes, at step 2901, inserting the frame member into an opening of a housing (e.g., housing 2110, 2310, 2410, or related embodiments thereof) of the battery cell such that the removable side forms a front panel of the housing. Method 2900 also includes, at step 2902, coupling the frame member to the housing using at least one fastener.

In some embodiments of method 2900: the removable side includes a center post, and the method also includes coupling the center post to opposite sides of the housing; the opposite sides of the housing are bowed out, and coupling the center post to the opposite side of the housing includes flattening the opposite sides; or the frame member is a bottom frame member, the removable side also includes a top frame member, and the method also includes coupling the top frame member to the housing using at least one fastener.

FIG. 30 shows a first approach 3000 for electrically coupling to a plurality of energy units 3002, in accordance with some embodiments of the present disclosure. An apparatus for the electrical coupling includes a first electrical conductor 3004 (e.g., which may correspond to electrical conductor 116b) that is electrically coupled to rim terminals 3006 of the energy units 3002. The first electrical conductor 3004 includes openings around respective center terminals 3008 of the energy units 3002. The apparatus also includes a second electrical conductor 3010 (e.g., which may correspond to electrical conductor 116a) that is electrically coupled to the center terminals 3008 of the energy units through the openings (e.g., via respective tabs 3012 of a plurality of tabs, e.g., which may correspond to the plurality of tabs 118). In some embodiments, the second electrical conductor includes a plurality of bar segments 3014, and the plurality of tabs extends from the plurality of bar segments. The apparatus also includes an insulator layer 3016 arranged between the first electrical conductor 3004 and the second electrical conductors 3010 to prevent electrical coupling therebetween.

FIG. 31 shows an assembly flow 3100 for the first approach 3000 for electrically coupling to the plurality of energy units 3002, in accordance with some embodiments of the present disclosure. In some embodiments, the first electrical conductor 3004 includes an electrically conductive sheet layer 3102 including the openings, and the first electrical conductor also includes a current collector layer including a plurality of bar segments 3104 that are electrically coupled to the electrically conductive sheet layer.

As shown in FIG. 31, the assembly flow 3100 includes applying the electrically conductive sheet layer 3102 over the plurality of energy units 3002 such that the openings of the electrically conductive sheet layer expose at least the respective center terminals 3008 and such that respective portions of the electrically conductive sheet layer surrounding the openings electrically couple to corresponding rim terminals 3006. The assembly flow 3100 also includes electrically coupling the current collector layer, including the plurality of bar segments 3104, to the electrically conductive sheet layer 3102.

In some embodiments, the first electrical conductor 3004 (e.g., the current collector layer thereof) also includes a first contact 3106, which may be electrically coupled to a first electrical terminal (e.g., an battery cell terminal 114, or any other suitable electric terminal) of a prismatic battery cell (e.g., any of the first type of prismatic battery cell 100, the second type of prismatic battery cell 900, the third type of prismatic battery cell 4600, or related embodiments thereof).

As further shown in FIG. 31, the assembly flow 3100 includes applying insulator layer 3016 over the plurality of bar segments 3104 and over at least a portion of the electrically conductive sheet layer 3102. The assembly flow 3100 also includes applying the second electrical conductor 3010 over the insulator layer 3016 and applying the plurality of tabs 3012 between at least one bar segment 3014 of the plurality of bars and a respective center terminal 3008. In some embodiments, the second electrical conductor 3010 also includes a second current collector including a second contact 3116, and the second contact is electrically coupled to a second electrical terminal of the battery cell.

For example, first electrical conductor 3004 may provide a parallel electrical coupling between respective rim terminals 3006 (e.g., negative terminals) of energy units 3002 and a negative electrical terminal (e.g., battery cell terminal 114b) of the prismatic battery cell, and second electrical conductor 3010 may provide a parallel electrical coupling between respective center terminals 3008 (e.g., positive terminals) of energy units 3002 and a positive electrical terminal (e.g., battery cell terminal 114a) of the prismatic battery cell. In some embodiments, at least two wires, busbars, or other suitable electrical contacts are provided to electrically couple the contacts 3106 and 3116 to respective electrical terminals (e.g., as extend through to an exterior side of a housing) of the prismatic battery cell.

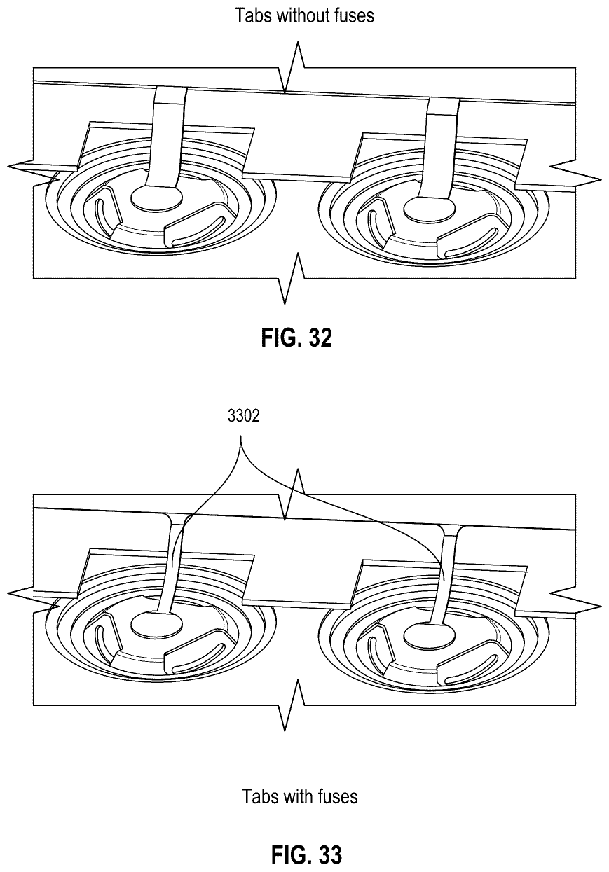

FIG. 32 shows electrical coupling tabs (e.g., the plurality of tabs 3012) without fuses, in accordance with some embodiments of the present disclosure. FIG. 33 shows electrical coupling tabs (e.g., the plurality of tabs 3012) with fuses, in accordance with some embodiments of the present disclosure. As shown in FIG. 33, each tab of the plurality of tabs with fuses includes a narrow portion 3302, where the narrow portion forms the fuse. The narrow portion may function as a fuse by melting or otherwise rupturing in response to conducting a current that exceeds a threshold limit. The electrical connections described in connection with at least FIGS. 30-31 may use the tabs without fuses of FIG. 32, the tabs with fuses of FIG. 33, or any combination thereof.

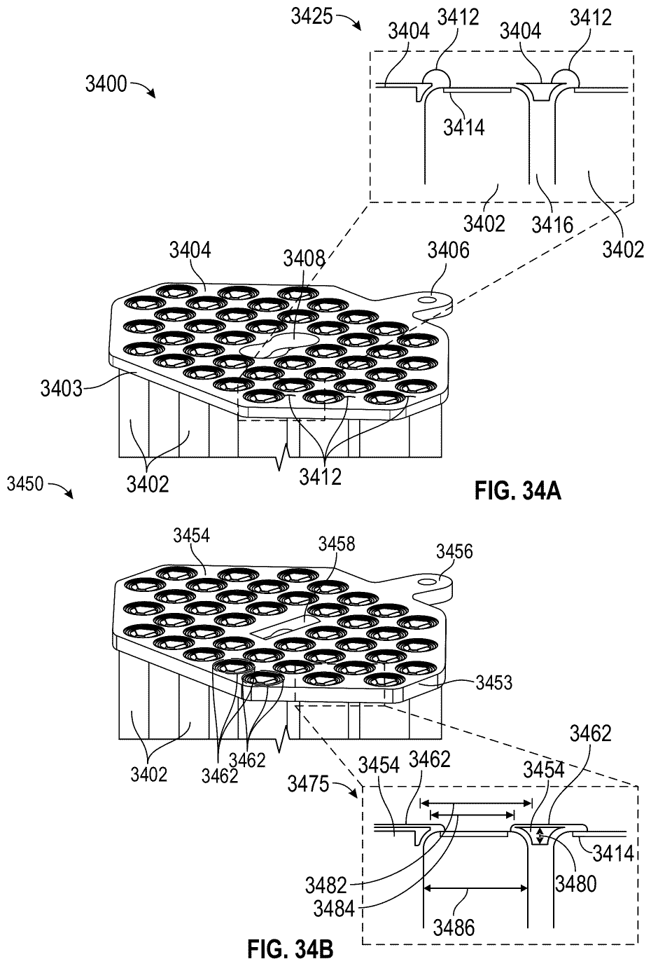

FIG. 34A shows a first approach 3400 for mechanically aligning a plurality of energy units 3402 via an electrical conductor (e.g., the electrical conductor including electrically conductive sheet layer 3404 and current collector layer 3403), in accordance with some embodiments of the present disclosure. The apparatus shown in FIG. 34A includes the plurality of energy units 3402, each including an end having a rim terminal 3414, and the first electrical conductor including a plurality of openings. As depicted in perspective 3425, the first electrical conductor is arranged over the ends of the energy units 3402 such that each end extends at least partially into a respective opening of the first electrical conductor, the openings provide a lateral constraint to the ends the energy units (e.g., for mechanical alignment and/or support), and the first electrical conductor is electrically coupled to the rim terminals 3414. In some embodiments, wire bonds 3412 electrically couple the first electrical conductor to the respective rim terminals 3414. The first electrical conductor has a contact 3406 (e.g., which may correspond to contact 3106 or any other suitable contact) and a curved opening 3408. In some embodiments, curved opening 3408 is configured such that a center post (e.g., center post 300 or related embodiments thereof) may pass through the plurality of energy units 3402 and provide mechanical support to a prismatic battery cell that encloses at least the apparatus of FIG. 34A.

FIG. 34B shows a second approach 3450 for mechanically aligning the plurality of energy units 3402 via an electrical conductor (e.g., the electrical conductor including electrically conductive sheet layer 3454 and current collector layer 3453), in accordance with some embodiments of the present disclosure. The apparatus shown in FIG. 34B is similar to the apparatus shown in FIG. 34A, except the former has an elongated opening 3458 (in contrast to curved opening 3408) to accommodate the center post, and the former uses laser welds 3462 (in contrast to wire bonds 3412) to electrically couple the electrically conductive sheet layer 3454 to the respective rim terminals 3414. It is noted that the electrical conductor of FIG. 34B may also be referred to as a first electrical conductor.

In connection with FIG. 34 (e.g., with reference to perspectives 3425 and 3475), the electrical conductor may provide a lateral constraint to the ends of energy units (e.g., energy units 3402) as follows. The plurality of openings in the electrical conductor each includes a depth 3480, which may correspond to a maximum thickness of the electrical conductor. Discussing this plurality of openings from the top down, the ends of the energy units extend past a threshold distance (e.g., greater than 25%, greater than 50%, or greater than 100%) of the depth 3480 of the openings. The openings are curved, such that there is a maximum diameter 3482 associated with a first plane that traverses a respective opening parallel to the end of an energy unit, and there is a minimum diameter 3484 associated with a second plane that traverses the respective opening parallel to the end of an energy unit. Based on the curvature of an opening, the maximum diameter 3482 and the minimum diameter 3484 are associated with different heights along the depth 3480. The maximum diameter 3482 is greater than an outer diameter 3486 of the energy units, and the minimum diameter 3484 is less than the outer diameter 3486, such the curved portion of each opening substantially surrounds both sides of the top edge of the end of each energy unit.

In some embodiments, the electrical conductor sheet layer (e.g., electrically conductive sheet layer 3404 or 3454) includes a plurality of openings with the minimum diameter 3484 and the current collector layer (e.g., current collector layer 3403 or 3453) includes a plurality of openings with the maximum diameter 3482. In some embodiments, the electrically conductive sheet layer is electrically coupled to the rim terminals 3414 (e.g., via wire bonds 3412 or laser welds 3462).

The depth 3480 of the openings fills at least a portion of each gap 3416 between adjacent ones of the energy units 3402. In some embodiments, the remainder of the gap 3416 is filled with air, thermally conductive potting material 1802, adhesive 2006, any other suitable material, or any combination thereof. With the edge of each opening of the electrical conductor arranged at least partially in the gap 3416 and at least partially around a corresponding edge of an end of an energy unit 3402, the stiffness of the electrical conductor provides mechanical alignment and/or support (including a lateral constraint) to prevent each energy unit 3402 from sliding, tipping, or otherwise moving into the gap 3416.

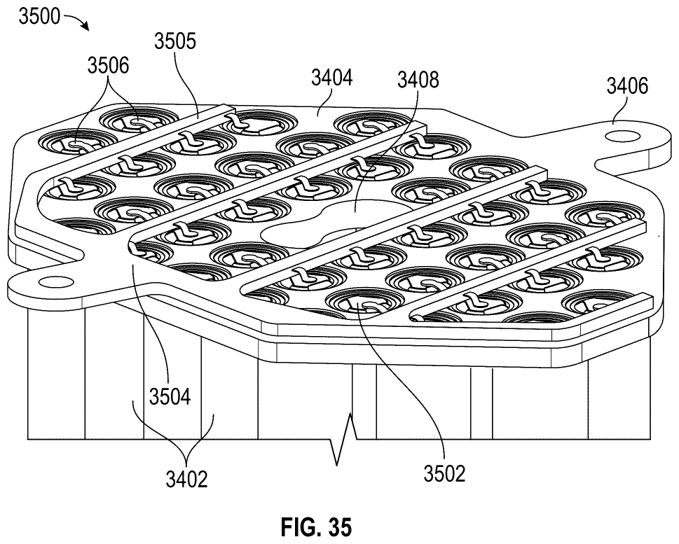

FIG. 35 shows a second approach 3500 for electrically coupling to a plurality of energy units, in accordance with some embodiments of the present disclosure. In some embodiments, the second approach 3500 may be used in connection with either of the mechanical alignment approaches shown in FIG. 34. In FIG. 35 the end of each energy unit 3402 also includes a center terminal 3502. The apparatus shown in FIG. 35 includes either of the first electrical conductors of FIG. 34, and it also includes a second electrical conductor 3504 that is electrically coupled to the center terminals 3502 through the plurality of openings in the first electrical conductor. In some embodiments, the apparatus of FIG. 35 also includes insulator layer 3610 (e.g., similar to insulator layer 3016, albeit with a geometry corresponding to second electrical conductor 3504) that is arranged between the first and second electrical conductors.

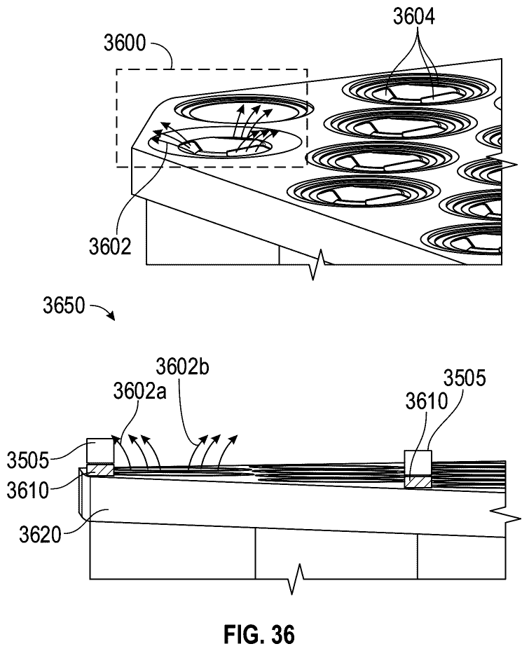

In some embodiments, second electrical conductor 3504 includes a plurality of bar segments 3505, and the bar segments are coupled to the center terminals 3502 using a plurality of tabs 3506 (which may, e.g., correspond to either of the tabs show in FIGS. 32-33). As is further described in connection with FIG. 36, certain ones of the plurality of bar segments 3505 are configured to couple to multiple rows of energy units 3402 to minimally occupy a volume of the plane extending above the ends of the plurality of energy units 3402.

FIG. 36 shows a thermal runaway path 3600 associated with the second approach 3500 for electrically connecting to a plurality of energy units, in accordance with some embodiments of the present disclosure. It is noted that within the boxed region depicting thermal runaway path 3600, certain elements of the ends of the energy units are omitted for clarity of the illustration. In response to a thermal condition, one or more energy units may produce outgas flows 3602 that propagate through thermal vents 3604. As mentioned above, the second approach 3500 may reduce a constraint on the outgas flows 3602 by minimally constraining volume of the thermal runaway path 3600.

FIG. 36 also shows an apparatus 3650 that is provided in connection with thermal runaway path 3600. Apparatus 3650 may correspond to the apparatus shown in FIG. 35, and this apparatus includes first conductor 3620 (e.g., either of the first conductors of FIG. 34), insulator layer 3610, and bar segments 3505 of second electrical conductor 3504. As shown, the small height of the stack including each insulator layer 3610 and each bar segment 3505 minimally impedes the outgas flows 3602a, and the open space (e.g., as is made available by the arrangement of the plurality of bar segments 3505) around other portions of the edge of the corresponding end of the energy unit does not impede outgas flows 3602b.

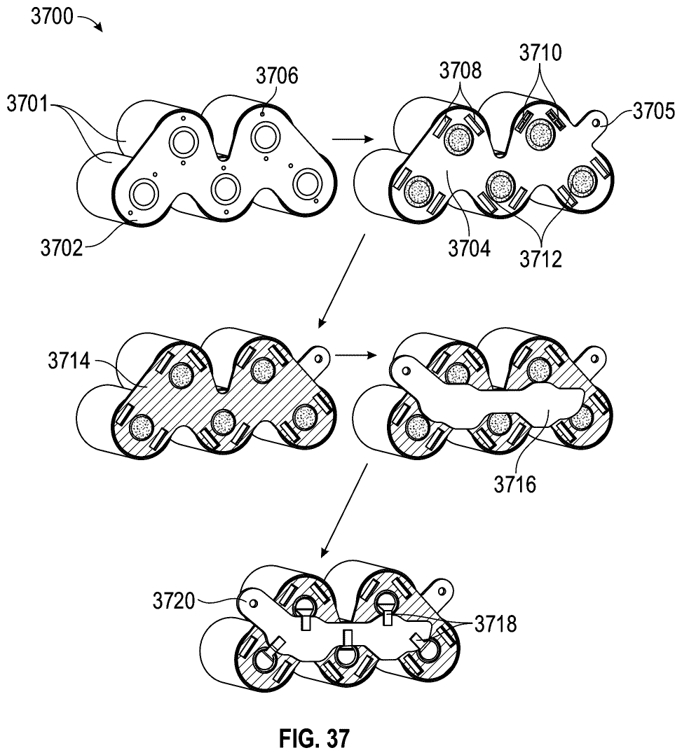

FIG. 37 shows a third approach 3700 for electrically coupling to a plurality of energy units, in accordance with some embodiments of the present disclosure. In some embodiments, the third approach 3700 is used in connection with the third type of prismatic battery cell 4600. The apparatus used in connection with the third approach 3700 includes a first electrical conductor, which includes first electrically conductive sheet layer 3702 and first current collector layer 3704. First electrically conductive sheet layer 3702 is electrically coupled to the multiple energy units 3701 (e.g., to respective rim terminals of these multiple energy units) and includes a plurality of holes 3706. In some embodiments, the apparatus also includes an adhesive applied to each of the plurality of holes 3706, such that the adhesive bonds the first current collector layer 3704 and/or the first electrically conductive sheet layer 3702 to each of the multiple energy units 3701 through the plurality of holes.

As shown, the first current collector layer 3704 is arranged over and electrically coupled to first electrically conductive sheet layer 3702. First current collector layer 3704 includes first contact 3705, which may connect to a first terminal of the third type of prismatic battery cell 4600 or any other suitable battery cell enclosing the apparatus of the third approach 3700. First current collector layer 3704 also includes a plurality of weld windows 3708, and the first current collector layer may be electrically coupled to respective rim terminals of the multiple energy units 3701 via weld joints 3710 (e.g., that are made through weld windows 3708). The first electrically conductive sheet layer 3702 includes first openings and the first current collector layer 3704 includes second openings, where the first openings are aligned with the second openings. Thus, each of these aligned first and second openings corresponds to one of the openings of a first electrical conductor that includes at least first electrically conductive sheet layer 3702 and first current collector layer 3704. In some embodiments, each of the plurality of second openings is concentric with and smaller than a respective one of the plurality of openings in the composite electrical conductor.

In some embodiments, inner edges of the first current collector layer 3704 (e.g., the inner edges of the abovementioned second openings) include electrically insulating dielectric material 3712. The electrically insulating dielectric material 3712 may prevent the first current collector layer 3704 from electrically coupling to respective center terminals of the multiple energy units 3701.

Proceeding through the assembly flow of the third approach 3700, insulator layer 3714 may be applied over the first current collector layer 3704. Insulator layer 3714 may have a geometry that is substantially similar to first electrically conductive sheet 3702, including corresponding openings. Second current collector layer 3716 may be applied over at least a portion of insulator layer 3714, and a plurality of tabs 3718 may be applied (e.g., through the openings in the first electrical conductor) to electrically couple second current collector layer 3716 to respective center terminals of the multiple energy units 3701. Second current collector layer 3716 may also include second contact 3720, which may connect to a second terminal of the third type of prismatic battery cell 4600 or any other suitable battery cell enclosing the apparatus of the third approach 3700.

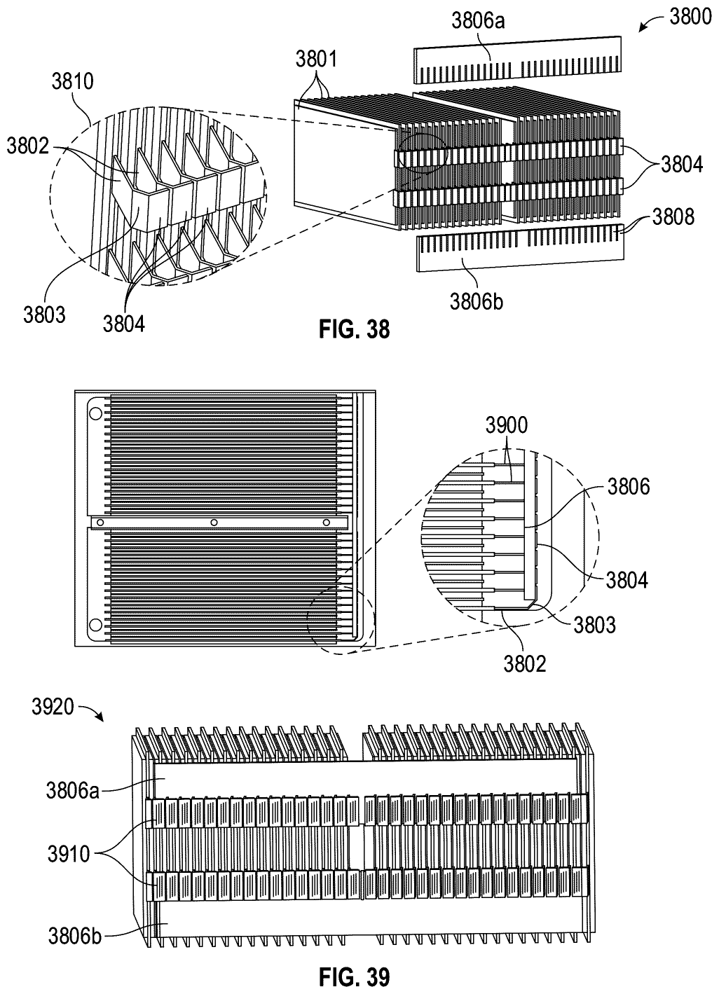

FIG. 38 shows a fourth approach 3800 for electrically coupling to a plurality of energy units, in accordance with some embodiments of the present disclosure. An apparatus provided in connection with the fourth approach 3800 includes a plurality of pouch energy units 3801 and a plurality of electrical tabs 3900, each of the pouch energy units including two electrically isolated tabs (e.g., corresponding to positive and negative terminals of the respective energy unit). Each of the electrical tabs 3900 has a bent end 3804. The apparatus provided in connection with the fourth approach 3800 also includes at least one current collector 3806 arranged across the plurality of pouch energy units 3801. The current collector includes a plurality of tines 3808. Each tine extends behind a respective bent end 3804 to electrically couple to the corresponding electrical tab 3900.

As shown in the inset 3810, each electrical tab 3900 includes a first end portion 3802 extending outward from a respective pouch energy unit 3801 a second end portion (e.g., the portion to which reference numeral 3804 extends) including the bent end 3804. The bent end 3804 is approximately perpendicular to the first end portion 3802. In some embodiments, each electrical tab 3900 includes a middle portion 3803 between the first end portion 3802 and the second end portion (including bent end 3804), and the middle portion includes a curve or one or more bends. For example, the middle portion 3803 may include two approximately 45 degree bends (e.g., where a first of the two bends makes an approximately 45 degree angle with the first end portion 3802, and a second of the two bends makes an approximately 45 degree angle with the second end portion including bent end 3804).

FIG. 39 shows various aspects of the fourth approach 3800 for electrically coupling to a plurality of energy units, in accordance with some embodiments of the present disclosure. Additional details are provided showing how each current collector 3806 sits behind the bent end 3804 of each electrical tab 3900. The first end portion 3802 of each electrical tab extends to the current collector 3806, and the middle portion 3803 may traverse the opening between neighboring tines 3808. In some embodiments, each bent end 3804 includes a first surface (e.g., the visible surface in FIG. 38) and an opposite second surface contacting the corresponding tine 3808, and each bent end 3804 is electrically coupled to the corresponding tine 3808 based on a weld 3910. For example, the welds 3910 may be laser welds or any other suitable welds.

FIG. 39 shows how the fourth approach 3800 includes two current collectors 3806a and 3806b, each of which may be electrically coupled to a respective group of the electrical tabs 3900. Both of the current collectors contain a plurality of tines 3808 and extend behind bent ends 3804 of the corresponding group of electrical tabs 3900. Tines 3808 of the first current collector 3806a couple to respective bent ends 3804 of the first group of electrical tabs 3900, and tines 3808 of the second current collector 3806b couple to respective bent ends of the second group of the electrical tabs. In some embodiments, the first group of electrical tabs 3900 are of a first polarity, the second group of electrical tabs 3900 are of a second polarity, first current collector 3806a is electrically coupled to a first electrical terminal (e.g., battery cell terminal 114a) corresponding to the first polarity, and second current collector 3806b is electrically coupled to a second electrical terminal (e.g., battery cell terminal 114b) corresponding to the second polarity.

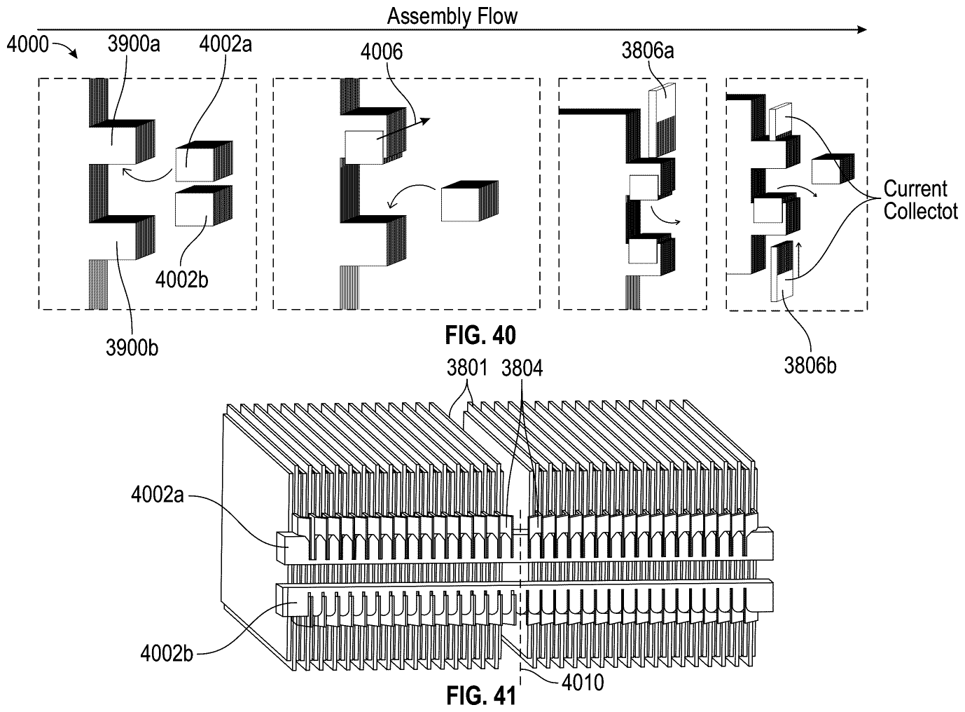

FIG. 40 shows a first partial assembly flow 4000 associated with the fourth approach for electrically coupling to a plurality of energy units, in accordance with some embodiments of the present disclosure. First partial assembly flow 4000 includes the use of first three-dimensional (3D) guide fixture 4002a (e.g., for aligning the first group of electrical tabs 3900a), second 3D guide fixture 4002b (e.g., for aligning the second group of electrical tabs 3900b), or both. In some embodiments, as shown in the left-most and second-from-the-left panels of FIG. 40, first 3D guide fixture 4002a is applied over first group of electrical tabs 3900a, and the first 3D guide fixture is pulled in first direction 4006 to arrange bent ends 3804 of the first group of electrical tabs 3900a such that tines 3808 of current collector 3806 may be inserted behind the bent tabs. The aforementioned step may be repeated for second guide fixture 4002b and second group of electrical tabs 3900b. As shown in the second-from-the-right panel of FIG. 40, first current collector 3806a may be inserted behind the bend tabs (e.g., based on the alignment provided by first 3D guide fixture 4002a), after which first 3D guide fixture 4002a may be removed. As shown in the right-most panel of FIG. 40, the aforementioned steps may be repeated for second current collector 3806b and second 3D guide fixture 4002b, such that tines 3808 of first current collector 3806a and tines of second current collector 3806b are oriented towards each other. It is noted that the solid arrows of FIG. 40 indicate directions of insertion/removal associated with the first partial assembly flow 4000.

FIG. 41 shows guide fixtures 4002 used in connection with the first partial assembly flow 4000, in accordance with some embodiments of the present disclosure. The apparatus of FIG. 41 may correspond to the second-from-left-right panel of FIG. 40, after insertion of second 3D guide fixture 4002b. In some embodiments, as shown in FIG. 41, each group of the electrical tabs 3900a and 3900b includes a first subgroup (e.g., the electrical tabs 3900a or 3900b on the left side of center line 4010) and a second subgroup (e.g., the electrical tabs 3900a or 3900b on the right side of center line 4010), where the first subgroup is adjacent to the second subgroup. As shown, bent ends 3804 of the first subgroup are angled towards the second subgroup, and bent ends 3804 of the second subgroup are angled towards the first subgroup. In some embodiments, a center post (e.g., center post 500) may be positioned between the first and second subgroups (e.g., the center post may be positioned behind center line 4010 and parallel to pouch energy units 3801).

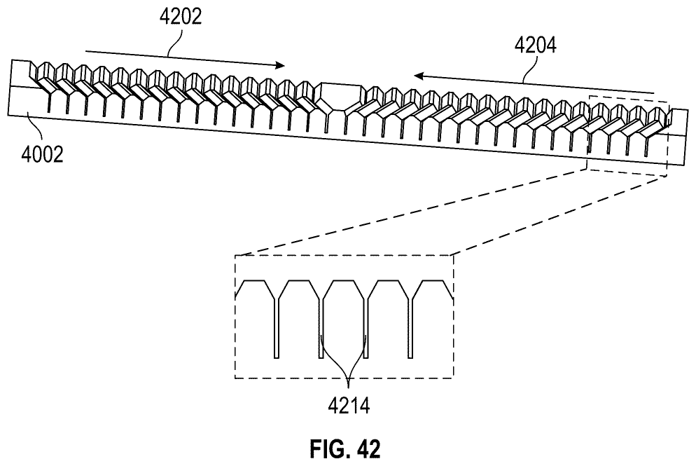

FIG. 42 shows additional details of 3D guide fixtures 4002, in accordance with some embodiments of the present disclosure. As shown, 3D guide fixture 4002 includes first and second groups of teeth, each of which is configured to align bent ends 3804 such that bent tabs of a first subgroup are angled toward bent tabs of the second subgroup. In other words, both subgroups of bent tabs are angled toward the center of 3D guide fixture 4002, as indicated by the alignment arrows 4202 (e.g., which indicates a direction of alignment of the first subgroup) and 4204 (e.g., which indicates a direction of alignment of the second subgroup). As shown in the inset, 3D guide fixtures 4002 include a plurality of openings 4214, which are configured such that electrical tabs 3900 can be inserted into these openings (e.g., during first partial assembly flow 4000). More specifically, the openings 4214 include angled lead-in sections that initiate the bending of electrical tabs 3900 as 3D guide fixture is moved between electrical tabs 3900. Once moved into position, the 3D guide fixture provides mechanical support for the first end portion 3802 and the middle portion 3803 of electrical tabs 3900.

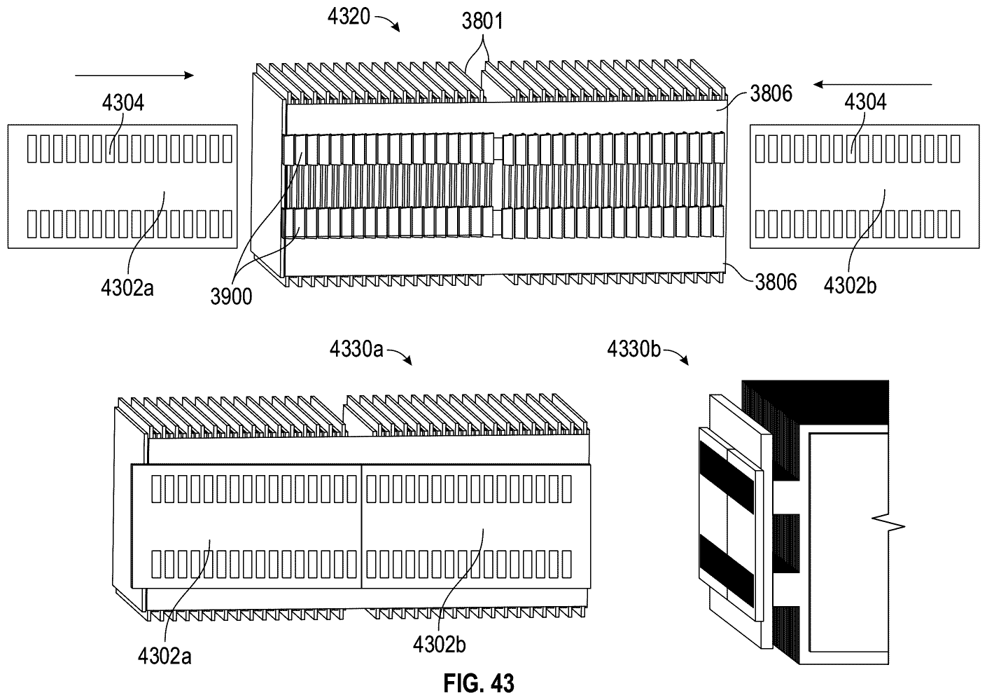

FIG. 43 shows pressing fixtures 4302 used in connection with the fourth approach for electrically coupling to a plurality of energy units, in accordance with some embodiments of the present disclosure. Pressing fixtures 4302 may be applied after first partial assembly flow 4000 to achieve the laser welds 3910, as further described below. In some embodiments, pressing fixtures 4302 are applied over apparatus 4320 (e.g., to form the bent ends 3804 and complete the bending of the electrical tabs 3900), which may correspond to apparatus 3920 before making laser welds 3910.

Apparatus 4320 includes current collectors 3806 arranged over the plurality of electrical tabs 3900. Each pressing fixture 4302 includes a plurality of openings 4304. When laterally arranging (e.g., according to the directionality of the arrows as shown in the top of FIG. 43) pressing fixtures 4302 over apparatus 4320, each of the openings 4304 may be arranged over a corresponding electrical tab 3900 (e.g., bent end 3804 of the electrical tab). The solid portions (e.g., between openings 4304) of pressing fixtures 4302 apply a force that pushes each of the electrical tabs 3900 into the corresponding current collector 3806. With sufficient force and/or mechanical contact/proximity between the electrical tabs 3900 and the corresponding current collector 3806, the electrical tabs can be coupled to the corresponding current collector using laser welds 3910 (e.g., where the laser welds occur through the openings 4304) or any other suitable electrical contact approach. As shown, first pressing fixture 4302a may correspond to the first subgroup of first and second groups of electrical tabs 3900, and second pressing fixture 4302b may correspond to the second subgroup of first and second groups of electrical tabs 3900.

Front perspective view 4330a depicts an apparatus including pressing fixtures 4302 arranged over apparatus 4320 (e.g., prior to applying laser welds 3910). Side perspective view 4330b depicts the same apparatus, showing how pressing fixtures 4302 are in direct contact with current collectors 3806, which are arranged in front of (and without directly contacting) the plurality of pouch energy units 3801.

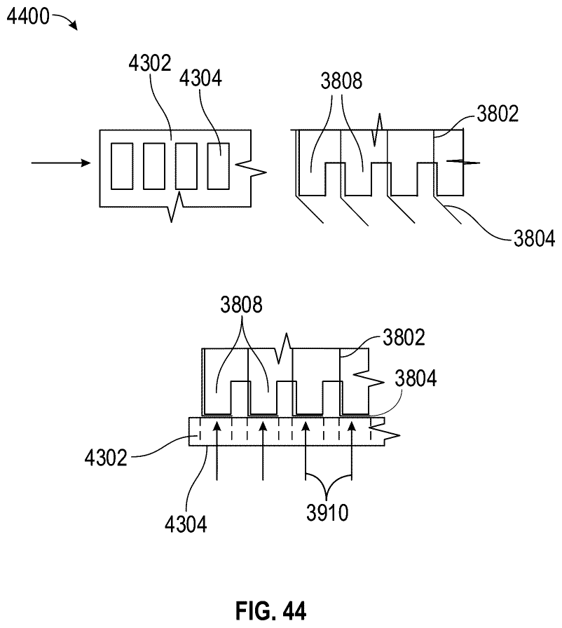

FIG. 44 shows a second partial assembly flow 4400 associated with the fourth approach for electrically coupling to a plurality of energy units, in accordance with some embodiments of the present disclosure. In some embodiments, second partial assembly flow 4400 follows first partial assembly flow 4000. Second partial assembly flow 4400 includes using pressing fixture 4302 to press bent ends 3804 (e.g., which extend away from tines 3808 prior to being pressed by the pressing fixture) against tines 3808. Second partial assembly flow 4400 also includes, after pressing fixture 4302 is arranged over bent ends 3804, welding bent ends 3804 to tines 3808. In some embodiments, the welding includes applying laser welds 3910 through openings 4304 (e.g., as indicated by the dashed lines) in pressing fixture 4302, as shown in the bottom of FIG. 44. It is noted that for illustrative purposes, the top row of FIG. 44 is show from a front view (with a perspective applied to the bent ends 3804, for clarity) of the corresponding assembly step, and the bottom row of FIG. 44 is shown from a top-down view of the corresponding assembly step.

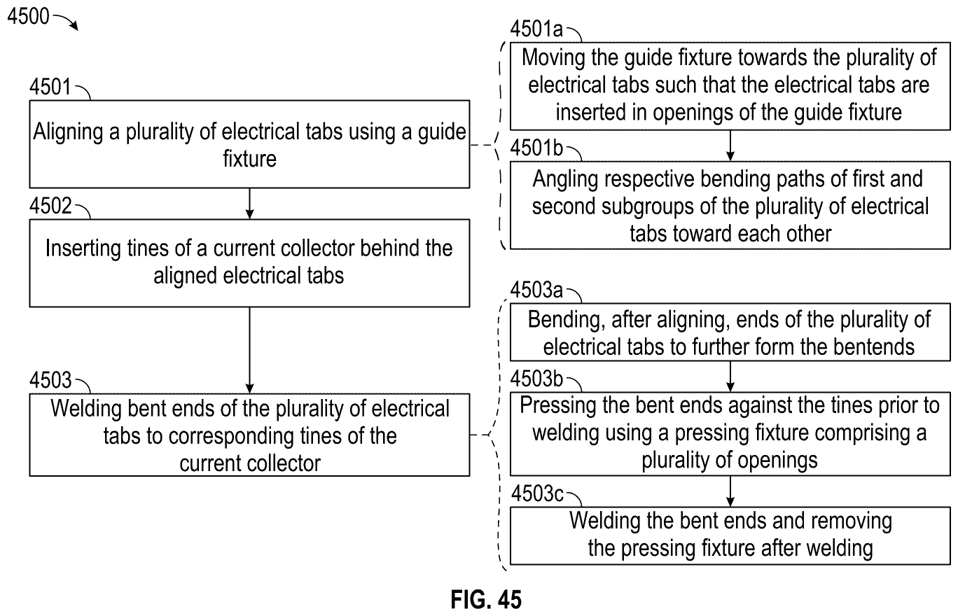

FIG. 45 shows a method 4500 for electrically coupling bent ends of a plurality of electrical tabs to a current collector, in accordance with some embodiments of the present disclosure. In some embodiments, method 4500 is used in connection with the elements and apparatuses of any one or more of FIGS. 38-44. In some embodiments, method 4500 is used in connection with the assembly of at least the second type of prismatic battery cell 900.

At step 4501, method 4500 includes aligning a plurality of electrical tabs (e.g., electrical tabs 3900) using a guide fixture (e.g., 3D guide fixture 4002). In some embodiments, step 4501 includes, at step 4501a, moving the guide fixture towards the plurality of electrical tabs such that the electrical tabs are inserted in openings (e.g., openings 4214) of the fixture. In some embodiments, the moving at step 4501a causes the guide fixture to form bent ends (e.g., bent ends 3804) in the plurality of electrical tabs. In some embodiments, step 4501 also includes, at step 4501b (e.g., as shown and described at least in connection with FIG. 41, including center line 4010, and FIG. 42), angling respective bending paths of first and second subgroups of the plurality of electrical tabs toward each other. In some embodiments, step 4501 corresponds to the two left-most panels of first partial assembly flow 4000. In some embodiments, the guide fixture includes first and second subgroups of the openings (e.g., corresponding to the first and second subgroups of electrical tabs, as described at least in connection with FIG. 41), the first subgroup of openings causes the inserted electrical tabs to bend towards the second subgroup, and the second subgroup of openings causes the inserted electrical tabs to bend towards the first subgroup.

At step 4502, method 4500 includes inserting tines (e.g., tines 3808) of a current collector (e.g., current collector 3806) behind the aligned electrical tabs. In some embodiments, step 4502 corresponds to the two right-most panels of first partial assembly flow 4000. In some embodiments, step 4502 also includes removing the guide fixture from a first side (e.g., the side of the guide fixture facing the middle of pouch energy units 3801) of the plurality of electrical tabs, and the tines are inserted behind the aligned electrical tabs from a second side (e.g., the side of the guide fixture facing an external edge of pouch energy units 3801) opposite the first side (e.g., as shown at least by the insertion/removal direction arrows illustrated in connection with the first partial assembly flow 4000).

At step 4503, method 4500 includes welding (e.g., using laser welds 3910) bent ends of the plurality of electrical tabs to corresponding tines of the current collector. In some embodiments, step 4503 includes, at step 4503a, bending, after aligning, ends of the plurality of electrical tabs to further form the bent ends. For example, the guide fixture at 4501b may partially form the bent ends (e.g., as shown in connection with the top row of FIG. 44), and a pressing fixture (e.g., pressing fixture 4302) may be used in connection with step 4503 to completely form the bent ends (e.g., as shown in connection with the bottom row of FIG. 44). In some embodiments, step 4503 also includes, at step 4503b, pressing the bent ends against the tines prior to welding using a pressing fixture (e.g., pressing fixture 4302) including a plurality of openings (e.g., openings 4304). In some embodiments, step 4503 also includes, at step 4503c, welding (e.g., to make laser welds 3910) the bent ends (e.g., through the plurality openings) and removing the pressing fixture after the welding.

FIG. 46A shows a front view of a third type of prismatic battery cell 4600 and its internal components, in accordance with some embodiments of the present disclosure. FIG. 46B shows a rear view of the third type of prismatic battery cell 4600 and its internal components, in accordance with some embodiments of the present disclosure. In some embodiments, prismatic battery cell 4600 includes energy units 712, thermal vent 702, exhaust plate 4702, burst disc 4808, coolant ports 1604, first interfaces 4708, second interfaces 4710, first current collector layer 3704, second current collector layer 3716, a plurality of tabs 3718, battery passport 904, and electrical output connector 906. In some embodiments, prismatic battery cell 4600 also includes battery cell terminals 4602a and 4602b (e.g., which may be similar to battery cell terminals 114). In some embodiments, prismatic battery cell 4600 also includes electrical connectors 4604a and 4604b, which electrically couple second current collector 3716 and first current collector 3704 (e.g., as are provided on the back side of the battery cell, as shown in FIG. 46B) to battery cell terminals 4602a and 4602b, respectively.

Third type of prismatic battery cell 4600 may be similar to first type of prismatic battery cell 100, with the former configured for use with center post 700/exhaust plate 4702 and the cooling system described in connection with FIG. 16, and the latter configured for use with center post 104 and the cooling system described in connection with FIGS. 12-15.

In some embodiments, the exhaust plate 4702 extends from a first side of the battery cell to a second side of the battery cell (e.g., to function as center post 700 or to otherwise provide mechanical support to a housing of the battery cell). Accordingly, in some embodiments, a composite yield strength of exhaust plate 4702 is at least 100 MPa.

In some embodiments, the prismatic battery cell 4600 is configured to be cooled by a liquid dielectric coolant that surrounds the plurality of energy units 712, such that the energy units 712 are submerged in the liquid dielectric coolant (e.g., as shown and described at least in connection with FIG. 16). In some embodiments, the liquid dielectric coolant is configured to enter the battery cell via an inlet port (e.g., inlet port 1604a) and exit via an outlet port (e.g., outlet port 1604d), and the ends of the energy units are affixed to the exhaust plate such that the vents are sealed from direct exposure to the liquid dielectric coolant.

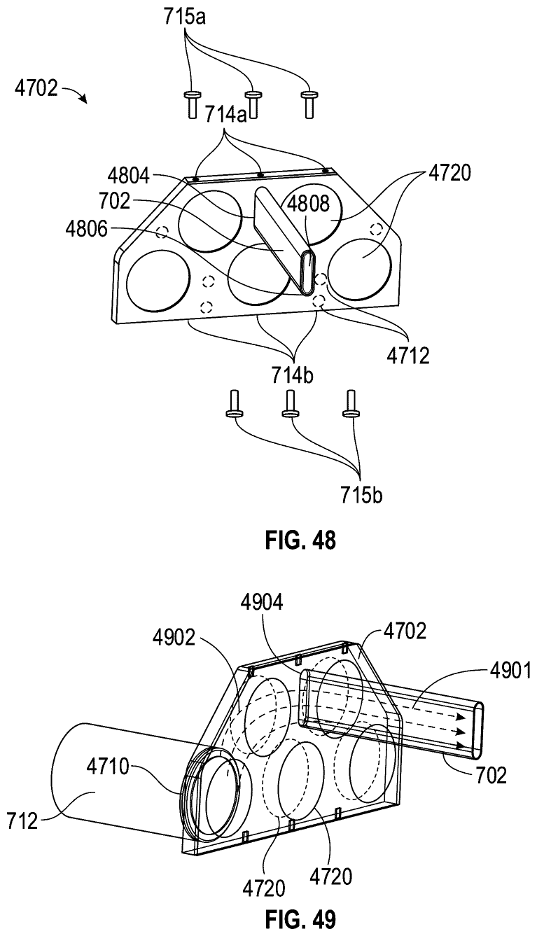

FIG. 47 shows energy unit interfaces associated with the third type of prismatic battery cell 4600, in accordance with some embodiments of the present disclosure. The energy unit interfaces are between respective energy units 712 and exhaust plate 4702. In some embodiments, exhaust plate 4702 corresponds to center post 700. Exhaust plate 4702 includes first side 4704 and second side 4706. Energy units 712 each have at least one vent at the end which is affixed to a corresponding side of exhaust plate 4702. In other words, first interfaces 4708 are between the first side 4704 of exhaust plate 4702 and the ends (e.g., with respective vents) of energy units 712a; second interfaces 4710 are between the second side 4706 of the exhaust plate and the ends (e.g., with respective vents) of energy units 712b. Based on this apparatus 4700, a gas that is released from any energy unit 712 may flow into exhaust plate 4702 (e.g., into passageway 4902 which extends between the first and second sides of the exhaust plate) and out of prismatic battery cell 4600 via a vent structure (e.g., thermal vent 702), as further described in connection with FIGS. 48-52.

In some embodiments, the energy units 712 each include first and second electric terminals (e.g., battery cell terminals 114) on an end opposite the end including the vent. For example, as shown in FIG. 46, electrical coupling may occur at these first and second electric terminals opposite the ends of the energy units 712 including the vent (e.g., at the respective ends opposite the first interfaces 4708 and the second interfaces 4710).

FIG. 48 shows aspects of exhaust plate 4702, in accordance with some embodiments of the present disclosure. Exhaust plate 4702 is coupled to a thermal vent 702 (e.g., a vent structure), which provides a pathway through which gas that is released from any energy unit 712 may flow out of a housing of a battery cell (e.g., housing 710 or any other suitable prismatic battery cell housing). As shown, thermal vent 702 includes a first end 4804 that is coupled to exhaust plate 4702 and a second end 4806 that includes an opening vented outside of the battery cell (e.g., as shown at least in FIG. 46). In some embodiments, the second end 4806 includes burst disc 4808, which may be configured to seal the second end 4806 while an internal pressure of thermal vent 702 is below a threshold, and to burst and release the gas inside thermal vent 702 when its internal pressure surpasses the threshold.

Exhaust plate 4702 also includes primary exhaust receivers 4720, which are present on the first and second sides of exhaust plate 4702 (e.g., as shown by the solid and dashed representations of FIG. 49). Primary exhaust receivers 4720 are provided on the sides of exhaust plates 4702 to achieve substantially airtight seals (e.g., at the first interfaces 4708 and the second interfaces 4710) between the vents of energy units 712 and the passageway 4902 inside exhaust plate 4702. In some embodiments, the primary exhaust receivers 4720 comprise holes and the ends of energy units 712 are secured to the perimeter of the holes using adhesive. In some embodiments, the primary exhaust receivers 4720 each comprise a recessed lip and a center hole. Sidewalls of the recessed lips may help maintain the lateral positioning of energy units 712 during assembly and operation. In some embodiments, a sealing member (e.g., an O-ring) is used in the recess to help achieve an airtight seal. Based on the orientation of the respective vents of energy units 712 and the primary exhaust receivers 4720, each respective vent is configured to release gas into the exhaust plate 4702 in response to a pressure (e.g., an internal pressure) of the respective energy unit exceeding a threshold. Exhaust plate 4702 also includes secondary exhaust receivers 4712, which are indicated by the dashed lines that represent holes in middle layer 5002, as further described at least in connection with FIG. 50.

Exhaust plate 4702 may also include fastener holes 708 (e.g., which may be aligned with fastener holes 714), which are configured to receive fasteners 715a to fasten, affix, or otherwise mechanically couple exhaust plate 4702 to a housing (e.g., housing 710) of a battery cell including exhaust plate 4702. In some embodiments, though not explicitly shown in FIG. 48, exhaust plate 4702 also includes bottom-side fastener holes 708b, which may be arranged across from the bottom-side fasteners 715b and opposite the top-side fastener holes 708a (as shown and referenced above). The bottom-side fasteners 715 may additionally fasten, affix, or otherwise mechanically couple exhaust plate 4702 to a corresponding battery cell housing.

FIG. 49 shows an exhaust path 4901 through exhaust plate 4702, in accordance with some embodiments of the present disclosure. As shown by the curved and dashed arrows, a respective exhaust path 4901 begins at any first interface 4708 or second interface 4710. In response to energy unit 712 releasing a gas, exhaust path 4901 includes passageway 4902 (e.g., which extends between the first and second sides of exhaust plate 4702), primary exhaust path opening 4904 (which is aligned with the opening of the thermal vent 702), and the interior of thermal vent 702. Thus, the gas may be released from a housing of a battery cell without substantially heating, corroding, or otherwise interacting with other energy units 712 of the battery cell that are not releasing any gas.

FIG. 50 shows a cross-sectional view of the exhaust plate 4702 and multiple energy units 712 coupled to the exhaust plate, in accordance with some embodiments of the present disclosure. In addition to the first side 4704 and the second side 4706, exhaust plate 4702 also includes middle layer 5002 arranged between the first side and the second side. In some embodiments, the middle layer divides passageway 4902 into two regions, and the middle layer includes at least one opening (e.g., secondary exhaust receivers 4712, which may also be referred to as secondary exhaust holes) between the two regions.

FIG. 51, shows aspects of the middle layer 5002 of the exhaust plate 4702, in accordance with some embodiments of the present disclosure. Middle layer 5002 includes a plurality of openings including primary exhaust path opening 4904 and the plurality of secondary exhaust receivers 4712. In some embodiments, secondary exhaust receivers 4712 are spaced apart from the primary exhaust path opening 4904, and/or they are arranged laterally away from the ends of the energy units with the vents (e.g., arranged laterally away from first interfaces 4708 and second interfaces 4710). In some embodiments, in response to any one or more energy unit 712 releasing a gas into exhaust plate 4702, secondary exhaust receivers 4712 improve a flowrate of gas through thermal vent 702 and/or reduce a back-pressure on the one or more gas-releasing energy unit 712 by providing an additional gas exhaust pathway (e.g., through middle layer 5002 and then through primary exhaust path opening 4904). In some embodiments, exhaust path 4901 includes a primary exhaust path (e.g., where a gas does not cross middle layer 5002 before entering thermal vent 702) and a secondary exhaust path (e.g., where a gas passes through middle layer 5002 via one or more secondary exhaust receiver 4712 before entering thermal vent 702).

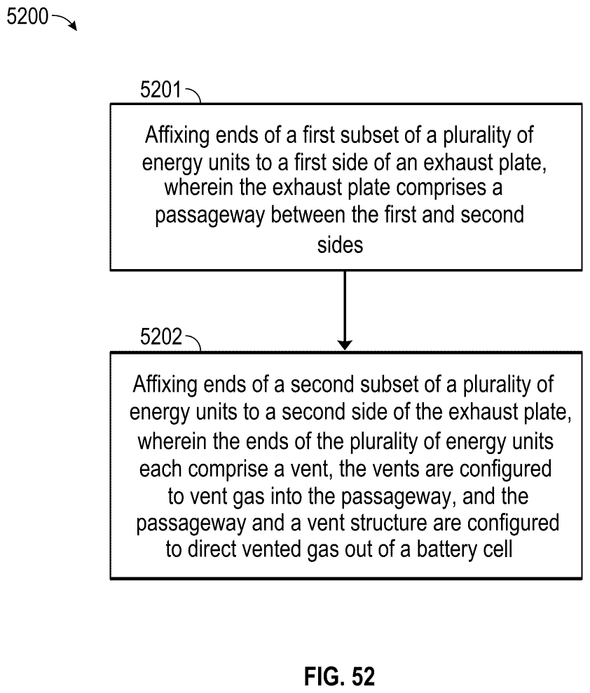

FIG. 52 shows a method 5200 for coupling a plurality of energy units (e.g., energy units 712) to an exhaust plate (e.g., exhaust plate 4702), in accordance with some embodiments of the present disclosure. At step 5201, method 5200 includes affixing ends of a first subset of the plurality of energy units to a first side (e.g., first side 4704) of an exhaust plate, wherein the exhaust plate comprises a passageway (e.g., passageway 4902) between the first and second sides. In some embodiments, adhesive is used to affix the ends of the first subset of the plurality of energy units to respective primary exhaust receivers (e.g., primary exhaust receivers 4720) of the first side. At step 5202, method 5200 includes affixing ends of a second subset of the plurality of energy units to a second side (e.g., second side 4706) of the exhaust plate, wherein the ends of the plurality of energy units each comprise a vent (e.g., thermal vents 3604) and the vents are configured to vent gas into the passageway. The passageway and a vent structure (e.g., thermal vent 702) are configured to direct vented gas out of a battery cell (e.g., the third type of prismatic battery cell 4600) (e.g., out of housing 710). In some embodiments, adhesive is used to affix the ends of the second subset of the plurality of energy units to respective primary exhaust receivers (e.g., primary exhaust receivers 4720) of the second side.

It is noted that various embodiments of the first type of prismatic battery cell 100 may include any element and/or teaching of at least FIGS. 1-4, 8, 12-15, and 17-36, taken alone or in any combination with any other elements or teachings of the present disclosure.

It is noted that various embodiments of the second type of prismatic battery cell 900 may include any element and/or teaching of at least FIGS. 2, 5-6, 8-11, 13, 17, 21-29, 32-33, 38-45, 8, 12-15, and 17-36, taken alone or in any combination with any other elements or teachings of the present disclosure.

It is noted that various embodiments of the third type of prismatic battery cell 4600 may include any element and/or teaching of at least FIGS. 7-8, 13, 16-17, 21-29, 32-33, 37, and 46-52, taken along or in any combination with any other elements or teachings of the present disclosure.

It is noted that any multi-part figures (e.g., FIG. 9A and FIG. 9B) may be collectively referenced by the shared figure number (e.g., FIG. 9). It is similarly noted that any multi-part reference numerals (e.g., 820a, 820b, and 820c) may be collective referenced by the shared reference numeral (e.g., 820).

It is noted that certain reference numerals are repeated across one or more figures. As will be understood by one of ordinary skill in the art, such repeated reference numerals may indicate that the corresponding elements are identical or substantially similar or possibly the same. However, two elements which may be identical or substantially similar or possibly the same may also, across two or more figures, be associated with different reference numerals.

It is noted that certain elements (e.g., including but not limited to energy units) may appear multiple times within a single figure. For clarity of illustration, each instance of such elements may not be explicitly labeled with a reference numeral. As will be understood by one of ordinary skill in the art, such unlabeled instances are not necessarily different from the corresponding labeled instances due to lacking a reference numeral; however, they are also not necessarily the same.

The processes described above are intended to be illustrative and not limiting. One skilled in the art would appreciate that the steps of the processes described herein may be omitted, modified, combined and/or rearranged, and any additional steps may be performed without departing from the scope of the invention. For example, it will be understood that while the figures generally depict prismatic battery cells, the disclosure is not limited to prismatic battery cells and the housings may be of any desired shape. It will also be understood that the elements of the disclosed battery cells may be used in different contexts. For example, the electrically coupling techniques shown in FIGS. 30-41 for energy units may be used to electrically couple individual battery cells (e.g., cylindrical battery cells and pouch battery cells) together.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations thereto and modifications thereof, which are within the spirit of the following claims.

What is claimed is:

1. A battery cell comprising:
a cooling structure;
a plurality of energy units thermally coupled to the cooling structure via a first interface; and
a thermally conductive potting material that thermally couples the plurality of energy units to each other and to the cooling structure via a second interface.

2. The battery cell of claim 1, wherein the thermally conductive potting material is electrically conductive.

3. The battery cell of claim 1, wherein a thermal conductivity of the thermally conductive potting material is at least 2 W/m*K.

4. The battery cell of claim 1, wherein an adhesive strength of the thermally conductive potting material is at least 10 MPa.

5. The battery cell of claim 1, wherein the plurality of energy units are cylindrical energy units arranged axially in parallel to each other.

6. The battery cell of claim 5, wherein:
the first interface is between a side of the cooling structure and respective ends of the cylindrical energy units; and
the second interface is between the side of the cooling structure and respective cylindrical sides of the energy units.

7. The battery cell of claim 1, wherein the plurality of energy units are electrically coupled in parallel.

8. The battery cell of claim 1, further comprising a housing having a removable side.

9. The battery cell of claim 8, wherein the cooling structure, the plurality of energy units, and the thermally conductive potting material are coupled to the removable side.

10. The battery cell of claim 8, wherein the removable side comprises two electrical terminals.

11. The battery cell of claim 1, wherein the thermally conductive potting material further couples the plurality of energy units to the cooling structure via the first interface.

12. The battery cell of claim 1, further comprising an adhesive, different than the thermally conductive potting material, that thermally couples the plurality of energy units to the cooling structure via the first interface.

13. An apparatus comprising:
a cooling structure;
a plurality of energy units; and
a thermally and electrically conductive potting material that thermally couples the plurality of energy units to each other and to the cooling structure.

14. The apparatus of claim 13, wherein a thermal conductivity of the thermally and electrically conductive potting material is at least 2 W/m*K.

15. The apparatus of claim 13, wherein an adhesive strength of the thermally and electrically conductive potting material is at least 10 MPa.

16. The apparatus of claim 13, wherein:
the plurality of energy units are thermally coupled to the cooling structure via a first interface; and
the thermally and electrically conductive potting material thermally couples the plurality of energy units to each other and to the cooling structure via a second interface.

17. The apparatus of claim 16, wherein the plurality of energy units are cylindrical energy units arranged axially in parallel to each other.

18. The apparatus of claim 17, wherein:
the first interface is between a side of the cooling structure and respective ends of the cylindrical energy units; and
the second interface is between respective cylindrical sides of the energy units and the side of the cooling structure.

19. The apparatus of claim 16, wherein the thermally and electrically conductive potting material further couples the plurality of energy units to the cooling structure via the first interface.

20. The apparatus of claim 13, wherein the plurality of energy units are electrically coupled in parallel.
